(19) United States
(12) Patent Application Publication
(10) Pub. No.: US 2017/0174854 A1
(43) Pub. Date: Jun. 22, 2017

(54) ABRASION RESISTANT MICROSPHERE ARTICLES

(71) Applicant: 3M INNOVATIVE PROPERTIES COMPANY, Saint Paul, MN (US)

(72) Inventors: John C. Clark, Maplewood, MN (US); Alexander J. Kugel, Woodbury, MN (US); Benjamin R. Coonce, South Saint Paul, MN (US); Vivek Krishnan, St. Paul, MN (US); Christopher B. Walker, JR., St. Paul, MN (US)

(21) Appl. No.: 15/129,099

(22) PCT Filed: Apr. 1, 2015
(86) PCT No.: PCT/US15/23758

§ 371 Date: Sep. 26, 2016

Related U.S. Application Data
(60) Provisional application No. 61/974,214, filed on Apr. 2, 2014.
(60) Provisional application No. 62/095,333, filed on Dec. 22, 2014.

(51) Int. Cl. C08J 7/04; B44C 5/04; B44C 1/17

(52) U.S. Cl. CPC C08J 7/047; B44C 1/1708; B44C 5/0476; C08J 2327/18; C08J 2475/08

(57) ABSTRACT

There is provided an article having a compliant article where the compliant article comprises an polymer layer and a first layer disposed along a first major surface of the polymer layer; and a plurality of microspheres partially embedded and adhered to a major surface of the first layer opposite the surface that is disposed along the first major surface of the polymer layer, wherein the article has a compression modulus of less than or equal to 0.5 MPa. There is also provided an article having a compliant article where the compliant article comprises a polymer layer; and a plurality of microspheres partially embedded and adhered to a major surface of the compliant article, where the article has a compression modulus of less than or equal to 0.5 MPa, and further where the article is a decorative article.

This disclosure relates to microsphere articles having improved abrasion resistance.

### BACKGROUND

Decorative protective surfaces find many consumer applications. Household appliances, automotive interiors and paints, consumer electronic devices, such as laptops and hand held devices, and apparel, such as clothing and footwear, are all examples where consumers prefer materials that deliver considerable protection from scratches, wear and abrasion while retaining good cosmetic appearance and aesthetics through the material's lifecycle. High quality conformable surfaces that are free of cracks and/or other defects when used in a broad temperature range are of particular interest to many consumers because of their aesthetic appeal.

Durable decorative laminates and films comprised of glass beads are broadly known. These low gloss constructions typically consist of exposed glass bead surfaces that impart high durability and decorative properties to the construction. Low friction properties of such constructions have also been disclosed. For example, U.S. Pat. No. 4,849,265 (Ueda) discloses decorative abrasion resistant laminates that contain hard microspheres (glass or plastic) that are either exposed or surface coated with a thin polymer coating. Another example is U.S. Pat. No. 5,620,775 (LaPerre), which discloses durable, low coefficient of friction polymeric films made by having an exposed glass bead surface with glass. Another example is U.S. Pat. No. 8,420,217 (Johnson) which discloses elastic bonding films that include an elastic, thermoset core layer and a thermoplastic bonding layer on each side of the core layer are described, where the thermoset core layer is a polyurethane formed as the reaction product of (i) a multifunctional isocyanate with (ii) a combination of polyols comprising (a) polyester diol, (b) crosslinker, and (c) hard segment.

There is a need for abrasion resistant microspheres articles that have a low coefficient of friction and are also free of visible defects. Specifically, there is a need for an abrasion resistant microsphere article that minimizes damage from even hard materials (such as, 3M WETORDRY P320 GRIT sandpaper, available from 3M Company, St. Paul, Minn.) and thus prolong the life and the aesthetics of the articles derived therefrom.

### SUMMARY

The present disclosure provides abrasion resistant microsphere articles having a low coefficient of friction and are also free of visible defects. The present disclosure also provides an abrasion resistant microsphere article that minimizes damage from even hard materials (such as, 3M WETORDRY P320 GRIT sandpaper) and thus prolong the life and the aesthetics of the articles derived therefrom. In one aspect, the present disclosure provides the following embodiments:

In one aspect, the present disclosure provides an article comprising a compliant article where the compliant article comprises a polymer layer and a first layer disposed along a first major surface of the polymer layer; and a plurality of microspheres partially embedded and adhered to a major surface of the first layer opposite the surface that is disposed along the first major surface of the polymer layer, where the article has a compression modulus of less than or equal to 0.5 MPa. In some embodiments, the first layer is selected such that the article exhibits a stain resistance to yellow mustard at elevated temperature and humidity as measured by the change in b* of less than 70. In some embodiments, the thickness of the compliant article is greater than 50 microns.

In some embodiments, the first layer is selected from at least one of linear resins and resins having low cross link densities. In some embodiments, the linear resins are selected from at least one of the following linear materials: polyurethanes, polyureas, polyurethane ureas, polypolyesters, polycarbonate, ABS, polyolefins, acrylic and methacrylic acid ester polymers and copolymers, polyvinyl chloride polymers and copolymers, polyvinyl acetate polymers and copolymers, polyamide polymers and copolymers, fluorine containing polymers and copolymers, silicones, silicone containing copolymers, thermoplastic elastomers, such as neoprene, acrylonitrile butadiene copolymers, and combinations thereof. In some embodiments, the article has an elongation percent at failure of greater than 26%.

In some embodiments, the plurality of microspheres are selected from at least one of glass, polymers, glass ceramics, ceramics, metals and combinations thereof.

In some embodiments, the article further comprises a second layer disposed along the second major surface of the compliant article. In some embodiments, the second layer comprises a flexible material. In some embodiments, the article is resistant to organic solvents. In some embodiments, the article exhibits a coefficient of friction of less than or equal to 0.3. In some embodiments, the article is heat bonded at elevated temperatures to a substrate.

In some embodiments, the polymer layer comprises an aliphatic polyurethane polymer comprising a plurality of soft segments, and a plurality of hard segments, wherein the soft segments comprise poly(alkoxy) polyol, polycarbonate polyol, or combinations thereof, wherein the soft segment is essentially free of crosslinker. In some embodiments, the soft segments have a number average molecular weight of less than 10,000 g/mol, and wherein the hard segments are derived from diols having molecular weights of less than 600 g/mol. In some embodiments, the soft segments have a number average molecular weight of at least 500 g/mol. In some embodiments, the soft segments have a number average molecular weight of 500 g/mol to 6,000 g/mol. In some embodiments, the soft segments have a number average molecular weight of 500 g/mol to 3,000 g/mol. In some embodiments, the compliant article has a thickness of 50 to 600 microns, and includes microspheres having an average diameter of about 30 to 200 microns. In some embodiments, the aliphatic polyurethane polymer contains less than 50 percent by weight hard segments and 15 to 90 percent by weight soft segments. In some embodiments, the total amount of hard and soft segments in the aliphatic polyurethane polymer is at least 90 percent by weight of the polymer.

In some embodiments, the article further comprises at least one additional layer disposed between the first layer and the polymer layer. In some embodiments, the article further comprises a second additional layer disposed between the polyurethane layer and the polymer layer. In some embodiments, the article has a gloss change at 85° Angle of less than or equal to 1.00 according the Abrasion Resistance Test.

In another aspect, the present disclosure provides an article comprising a compliant article wherein the compliant article comprises a polymer layer; and a plurality of microspheres partially embedded and adhered to a major surface of the compliant article, wherein the article has a compression modulus of less than or equal to 0.5 MPa, and further wherein the article is a decorative article. In some embodiments, the compliant article further comprises a first layer disposed between the polymer layer and the plurality of microspheres. In some embodiments, the first layer is selected such that the article exhibits a stain resistance to yellow mustard at elevated temperature and humidity as measured by the change in b* of less than 70. In some embodiments, the thickness of the compliant article is greater than 50 microns.

In some embodiments, the first layer is selected from at least one of linear resins and resins having low cross link densities. In some embodiments, the linear resins are selected from at least one of the following linear materials: polyurethanes, polyureas, polyurethane ureas, polypolyesters, polycarbonate, ABS, polyolefins, acrylic and methacrylic acid ester polymers and copolymers, polyvinyl chloride polymers and copolymers, polyvinyl acetate polymers and copolymers, polyamide polymers and copolymers, fluorine containing polymers and copolymers, silicones, silicone containing copolymers, thermoplastic elastomers, such as neoprene, acrylonitrile butadiene copolymers, and combinations thereof. In some embodiments, the article has an elongation percent at failure of greater than 26%. In some embodiments, the plurality of microspheres are selected from at least one of glass, polymers, glass ceramics, ceramics, metals and combinations thereof.

In some embodiments, the article further comprises a second layer disposed along the second major surface of the compliant article. In some embodiments, the second layer comprises a flexible material. In some embodiments, the article is resistant to organic solvents. In some embodiments, the article exhibits a coefficient of friction of less than or equal to 0.3. In some embodiments, the article is heat bonded at elevated temperatures to a substrate.

In some embodiments, the polymer layer comprises an aliphatic polyurethane polymer comprising a plurality of soft segments, and a plurality of hard segments, wherein the soft segments comprise poly(alkoxy) polyol, polycarbonate polyol, or combinations thereof, wherein the soft segment is essentially free of crosslinker. In some embodiments, the soft segments have a number average molecular weight of less than 10,000 g/mol, and wherein the hard segments are derived from diols having molecular weights of less than 600 g/mol. In some embodiments, the soft segments have a number average molecular weight of at least 500 g/mol. In some embodiments, the soft segments have a number average molecular weight of 500 g/mol to 6,000 g/mol. In some embodiments, the soft segments have a number average molecular weight of 500 g/mol to 3,000 g/mol. In some embodiments, the polymer layer has a thickness of 50 to 600 microns, and includes microspheres having an average diameter of about 30 to 200 microns. In some embodiments, the polyurethane polymer contains less than 50 percent by weight hard segments and 15 to 90 percent by weight soft segments. In some embodiments, the total amount of hard and soft segments in the polyurethane polymer is at least 90 percent by weight of the polymer. In some embodiments, the article has a gloss change at 85° Angle of less than or equal to 1.00 according the Abrasion Resistance Test.

The above summary of the present disclosure is not intended to describe each embodiment of the present invention. The details of one or more embodiments of the invention are also set forth in the description below. Other features, objects, and advantages of the invention will be apparent from the description and from the claims.

### BRIEF DESCRIPTION OF THE DRAWINGS

The disclosure may be more completely understood in consideration of the following detailed description of various embodiments of the disclosure in connection with the accompanying figures, in which:

FIG. 1 is a front cross section view of an embodiment of the presently disclosed article.

FIG. 2 is a front cross section view of an embodiment of the presently disclosed article.

FIG. 3 is a SEM micrograph of prior art article.

FIG. 4 is a SEM micrograph of an article according to the present disclosure.

While the above-identified drawings, which may not be drawn to scale, set forth various embodiments of the present disclosure, other embodiments are also contemplated, as noted in the Detailed Description. In all cases, this disclosure describes the presently disclosed invention by way of representation of exemplary embodiments and not by express limitations. It should be understood that numerous other modifications and embodiments can be devised by those skilled in the art, which fall within the scope and spirit of this disclosure.

### DETAILED DESCRIPTION

Before any embodiments of the invention are explained in detail, it is to be understood that the invention is not limited in its application to the details of construction and the arrangement of components set forth in the following description. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Any numerical range recited herein includes all values from the lower value to the upper value. For example, if a concentration range is stated as 1% to 50%, it is intended that values such as 2% to 40%, 10% to 30%, or 1% to 3%, etc., are expressly enumerated. These are only examples of what is specifically intended, and all possible combinations of numerical values between and including the lowest value and the highest value enumerated are to be considered to be expressly stated in this application.

The term “decorative article” as used herein means articles that have a coefficient of retro reflection of less than or equal to 1.0 candelas/lux/square meter. In some preferred embodiments, the presently disclosed articles have a coefficient of retro reflection of less than or equal to 0.5 candelas/lux/square meter. In some more preferred embodiments, the presently disclosed articles have a coefficient of retro reflection of less than or equal to 0.1 candelas/lux/square meter.

In some embodiments, the present disclosure provides articles having a compliant article where the compliant article comprises an polymer layer and a first layer disposed along a first major surface of the polymer layer; and a plurality of microspheres partially embedded and adhered to a major surface of the first layer opposite the surface that is disposed along the first major surface of the polymer layer, where the article has a compression modulus of less than or equal to 0.5 MPa. In some embodiments, the present disclosure provides articles having a compliant article wherein the compliant article comprises a polymer layer; and a plurality of microspheres partially embedded and adhered to a major surface of the compliant article, wherein the article has a compression modulus of less than or equal to 0.5 MPa, and further wherein the article is decorative article. In some embodiments, the thickness of the compliant article is greater than 50 microns.

In some embodiments, it is preferred that the article is thermoformable or stretchable. In order for the article to be thermoformable or stretchable, the materials in the article, such as the compliant article, must have certain properties. An exemplary test method for determining the stretchability is included in the tensile test conducted according to ASTM D882-10. In some embodiments, it is preferable that the article is free of visual defects, such as for example inhomogeneities (bubbles, dark spots, light spots, and the like).

The other criterion for the article to be formable is that it can bear the elongation that occurs during forming or stretching without failing, cracking, or generating other defects. This can be achieved by using materials that have a temperature at which they undergo melt flow and forming near that temperature. In some cases, crosslinked materials that do not flow can be used, but they are more likely to crack during the elongation. To avoid this cracking, the crosslink density should be kept low, as can be indicated by a low storage modulus in the rubbery plateau region. The expected degree of crosslinking can also approximated as the inverse of the average molecular weight per crosslink, which can be calculated based on the components of a material. In addition, in some embodiments forming can be conducted at relatively low temperatures, since as temperatures increase above the glass transition temperature of crosslinked materials, their capacity for elongation begins to decrease. For example, in some embodiments, the article has an elongation percent at failure of greater than 26%.

### Transfer Carrier

The transfer coating method of the present disclosure can be used to form a microsphere transfer article from which the presently disclosed article can be formed. The article has surprisingly improved aesthetics.

The presently disclosed transfer carrier includes a support layer and a thermoplastic release layer bonded thereto. The thermoplastic release layer of the transfer carrier temporarily partially embeds a plurality of transparent microspheres. The transfer carrier has low adhesion to the plurality of transparent microspheres and to the compliant article in which the opposite sides of the plurality of transparent microspheres are at least partially embedded, so that the transfer carrier can be removed to expose the surface of the plurality of transparent microspheres.

### Support Layers

The support layer should be “dimensionally stable”. In other words it should not shrink, expand, phase change, etc. during the preparation of the transfer article. Useful support layers may be thermoplastic, non-thermoplastic or thermosetting, for example. One skilled in the art would be able to select a useful support layer for the presently disclosed transfer article. If the support layer is a thermoplastic layer it should preferably have a melting point above that of the thermoplastic release layer of the transfer carrier. Useful support layers for forming the transfer carrier include but are not limited to those selected from at least one of paper and polymeric films such as biaxially oriented polyethylene terephthalate (PET), polypropylene, polymethylpentene and the like which exhibit good temperature stability and tensile strength so they can undergo processing operations such as bead coating, adhesive coating, drying, printing, and the like.

### Thermoplastic Release Layers

Useful thermoplastic release layers for forming the transfer carrier include but are not limited to those selected from at least one of polyolefins such as polyethylene, polypropylene, organic waxes, blends thereof, and the like. Low to medium density (about 0.910 to 0.940 g/cc density) polyethylene is preferred because it has a melting point high enough to accommodate subsequent coating and drying operations which may be involved in preparing the transfer article, and also because it releases from a range of materials that may be used in the compliant article, in addition to the plurality of transparent microspheres.

The thickness of the thermoplastic release layer is chosen according to the microsphere diameter distribution to be coated. The compliant article embedment becomes approximately the mirror image of the transfer carrier embedment. For example, a microsphere which is embedded to about 30% of its diameter in the release layer of the transfer carrier is typically embedded to about 70% of its diameter in the compliant article. To maximize slipperiness and packing density of the plurality of microspheres, it is desirable to control the embedment process so that the upper surface of smaller microspheres and larger microspheres in a given population end up at about the same level after the transfer carrier is removed.

In order to partially embed the plurality of microspheres in the release layer, the release layer should preferably be in a tacky state (either inherently tacky and/or by heating). The plurality of microspheres may be partially embedded, for example, by coating a plurality of microspheres on the thermoplastic release layer of the transfer carrier by one of steps (1)-(3): (1) heating the microsphere coated transfer carrier, (2) applying pressure to the microsphere coated transfer carrier (with, for example, a roller) or (3) heating and applying pressure to the microsphere coated transfer carrier.

For a given thermoplastic release layer, the microsphere embedment process is controlled primarily by temperature, time of heating and thickness of the thermoplastic release layer. As the thermoplastic release layer is melted, the smaller microspheres in any given population will embed at a faster rate and to a greater extent than the larger microspheres because of surface wetting forces. The interface of the thermoplastic release layer with the support layer becomes an embedment bonding surface since the microspheres will sink until they are stopped by the dimensionally stable support layer. For this reason it is preferable that this interface be relatively flat.

The thickness of the thermoplastic release layer should be chosen to prevent encapsulation of most of the smaller diameter microspheres so that they will not be pulled away from the compliant article when the transfer carrier is removed. On the other hand, the thermoplastic release layer must be thick enough so that the larger microspheres in the plurality of microspheres are sufficiently embedded to prevent their loss during subsequent processing operations (such as coating with the compliant article, for example).

### Microspheres

Microspheres useful in the present disclosure can be made from a variety of materials, such as glass, polymers, glass ceramics, ceramics, metals and combinations thereof. In some embodiments, the microspheres are glass beads. The glass beads are largely spherically shaped. The glass beads are typically made by grinding ordinary soda-lime glass or borosilicate glass, typically from recycled sources such as from glazing and/or glassware. Common industrial glasses could be of varying refractive indices depending on their composition. Soda lime silicates and borosilicates are some of the common types of glasses. Borosilicate glasses typically contain boria and silica along with other elemental oxides such as alkali metal oxides, alumina etc. Some glasses used in the industry that contain boria and silica among other oxides include E glass, and glass available under the trade designation “NEXTERION GLASS D” from Schott Industries, Kansas City, Mo., and glass available under the trade designation “PYREX” from Corning Incorporated, New York, N.Y.

The grinding process yields a wide distribution of glass particle sizes. The glass particles are spherodized by treating in a heated column to melt the glass into spherical droplets, which are subsequently cooled. Not all the beads are perfect spheres. Some are oblate, some are melted together and some contain small bubbles.

Microspheres are preferably free of defects. As used herein, the phrase “free of defects” means that the microspheres have low amounts of bubbles, low amounts of irregular shaped particles, low surface roughness, low amount of inhomogeneities, low amounts undesirable color or tint, or low amounts of other scattering centers.

When the article is stretched during a forming process, the relative positions of the microspheres on the surface of the compliant article will change. It is preferred that the change in position of the microspheres results in substantially uniform spacing. Substantially uniform spacing occurs when the distance between individual microspheres tends to increase as the article is deformed. This is in contrast to a less preferred situation when the distance between clusters of microspheres increases, but individual microspheres tend to remain close to each other. Also, if cracking occurs in the compliant article of an article, then gaps will grow between clusters of microspheres, and substantially uniform spacing will not occur. In some embodiments, the article can be elongated in one direction but not in another such that the microspheres tend to increase in separation in the direction of elongation but not increase in separation in the orthogonal direction. In this case, the resulting microspheres have substantially uniform spacing even though microspheres have relatively high separation in the direction of stretching but low separation in the orthogonal direction. Substantially uniform spacing is identified by observing the average distance between microspheres along any straight line on the surface of the film with a uniform distance between microspheres indicates uniform spacing. The average distances between microspheres when comparing two different lines in different directions on the surface of the film do not need to be similar to have substantially uniform spacing.

While not wishing to be bound by theory, it is believed that when microspheres are randomly applied in a full monolayer on a surface, they naturally have substantially uniform spacing because they are packed reasonably closely. However, if microspheres are randomly applied with lower area coverages, such as between 30% and 50% coverage, then they do not necessarily produce uniform spacing. For example, in some cases, clusters of several microspheres can form either by random or by electrostatic attraction leaving other areas on the surface void of microspheres. By first forming a more densely packed layer of microspheres and subsequently stretching the surface of the article, a more uniform spacing of microspheres can occur compared to a random placement of microspheres.

A substantially uniform spacing of microspheres in the formed articles is achieved when a proper balance of properties in the materials used in the article is provided.

### Particle Sizing

The microspheres are typically sized via screen sieves to provide a useful distribution of particle sizes. Sieving is also used to characterize the size of the microspheres. With sieving, a series of screens with controlled sized openings is used and the microspheres passing through the openings are assumed to be equal to or smaller than that opening size. For microspheres, this is true because the cross-sectional diameter of the microsphere is almost always the same no matter how it is oriented to a screen opening. It is desirable to use as broad a size range as possible to control economics and maximize the packing of the microspheres on the surface of the compliant article. However, some applications may require limiting the microsphere size range to provide a more uniform microsphere coated surface. In some embodiments, a useful range of average microsphere diameters is about 5 μm to about 200 μm (typically about 35 to about 140 μm, preferably about 35 to 90 μm, and most preferably about 38 to about 75 μm). A small number (0 to 5% by weight based on the total number of microspheres) of smaller and larger microspheres falling outside the 20 to 180 micron range can be tolerated. In some embodiments, a multi-modal size distribution of microspheres is useful.

In some embodiments, to calculate the “average diameter” of a mixture of microspheres one would sieve a given weight of particles such as, for example, a 100 gram sample through a stack of standard sieves. The uppermost sieve would have the largest rated opening and the lowest sieve would have the smallest rated opening. For our purposed the average cross-sectional diameter can be effectively measure by using the following stack of sieves.

```
U.S. Sieve Designation No.
Nominal Opening (microns).
  80 180
  100 150
  120 125
  140 106
170 90
200 75
230 63
270 53
325 45
400 38
500 25
635 20
```

Alternately, average diameter can be determined using any commonly known microscopic methods for sizing particles. For example, optical microscopy or scanning electron microscopy, and the like, can be used in combination with any image analysis software. For example, software commercially available as free ware under the trade designation “IMAGE J” from NIH, Bethesda, Md.

### Adhesion Promoter

In some embodiments, the microspheres are treated with an adhesion promoter such as those selected from at least one of silane coupling agents, titanates, organo-chromium complexes, and the like, to maximize their adhesion to the compliant article, especially with regard to moisture resistance.

The treatment level for such adhesion promoters is on the order of 50 to 1200 parts by weight adhesion promoter per million parts by weight microspheres. Microspheres having smaller diameters would typically be treated at higher levels because of their higher surface area. Treatment is typically accomplished by spray drying or wet mixing a dilute solution such as an alcohol solution (such as ethyl or isopropyl alcohol, for example) of the adhesion promoter with the microspheres, followed by drying in a tumbler or auger-fed dryer to prevent the microspheres from sticking together. One skilled in the art would be able to determine how to best treat the microspheres with an adhesion promoter.

### Compliant Article

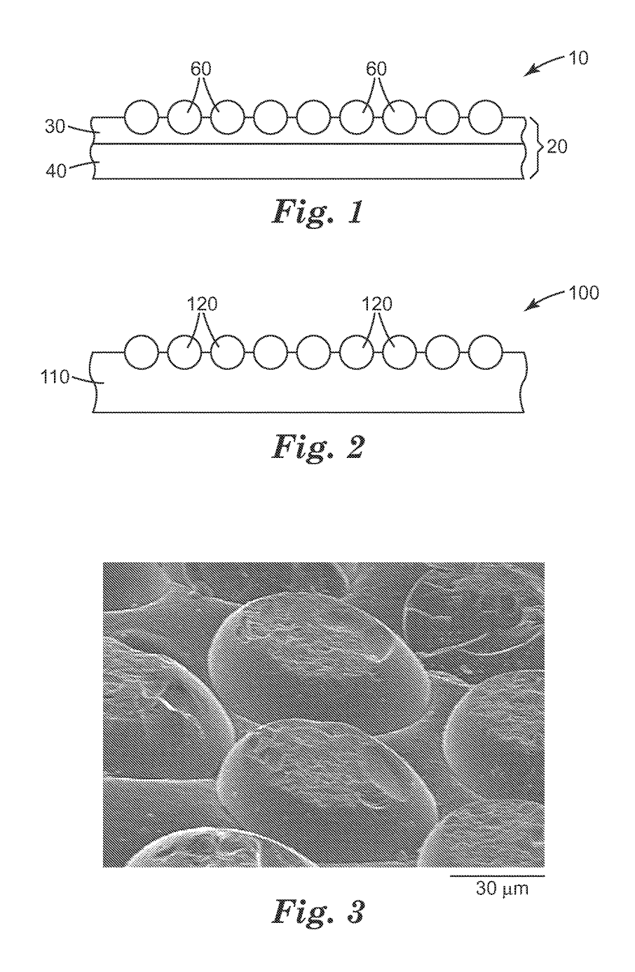

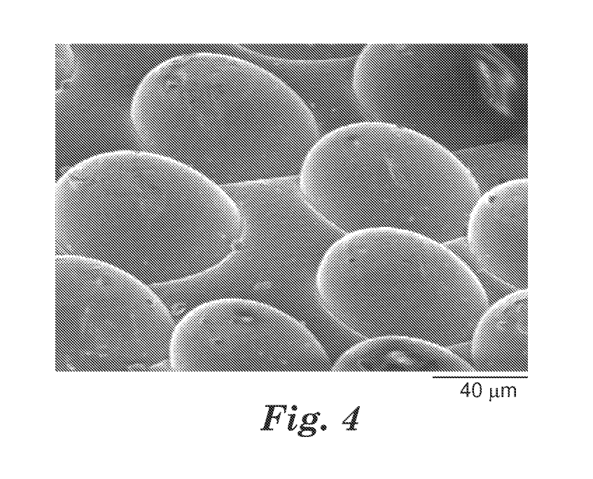

Referring now to FIG. 1, in some embodiments, the present disclosure provides an article 10 having a compliant article 20. In some embodiments, the compliant article 20 includes a polymer layer 40. In some embodiments, the compliant article 20 includes a first layer 30 disposed along one of the major surfaces of the polymer layer 40.

In some embodiments, the first layer 30 is disposed between the polymer layer 40 and a plurality of microspheres 60. For example, in some embodiments, the plurality of microspheres 60 may be partially embedded and adhered to a first major surface of the first layer 30. Referring now to FIG. 2, in some embodiments, an article 100 is provided in which a plurality of microspheres 120 are partially embedded and adhered to a first major surface of a polymer layer 110.

In some embodiments, there may be at least one optional additional layers disposed between the first layer 30 and the polymer layer 40. For example, in some embodiments, the at least one additional optional layer may be a layer of polymer, adhesive or both. This additional layer may be disposed, for example, along a major surface of the first layer that is opposite the first major surface in which the plurality of microspheres are partially embedded and adhered to. When more than one additional optional layer is used, they may be placed in a variety of configurations, such as for example, a layer of polymer disposed along a major surface of the first layer that is opposite the first major surface in which the plurality of microspheres are partially embedded and adhered to with a layer of adhesive disposed between the polymer layer and the polymer layer.

### Polymer Layer

The polymer layer is typically an organic polymeric material. It should exhibit good adhesion to the transparent microspheres themselves or to the treated microspheres. It is also possible that an adhesion promoter for the microspheres could be added directly to the polymer layer itself as long as it is compatible within the process window for disposing the polymer layer on the surfaces of the microspheres. It is important that the polymer layer has sufficient release from the thermoplastic release layer of the transfer carrier to allow removal of the transfer carrier from the microspheres, which are embedded on one side in the thermoplastic release layer and on the other side in the polymer layer.

Materials useful in the polymer layer include, but are not limited to those selected from at least one of the following linear materials: polyurethanes, polyureas, polyurethane ureas, polyesters, polycarbonate, ABS, polyolefins, acrylic and methacrylic acid ester polymers and copolymers, polyvinyl chloride polymers and copolymers, polyvinyl acetate polymers and copolymers, polyamide polymers and copolymers, fluorine containing polymers and copolymers, silicones, silicone containing copolymers, thermoplastic elastomers, such as neoprene, acrylonitrile butadiene copolymers, and combinations thereof. In some embodiments, a polymer matrix can be used in the polymer layer. For example, the polymer matrix composites include nanoparticles in resins, fibers in resins, and the like. Combinations can include any combinations of materials, such as interpenetrating networks, dual cure systems, and the like.

In some embodiments, the presently disclosed articles have polymer layers that are not crosslinked or are very lightly crosslinked. Lightly crosslinked materials can be useful over highly crosslinked materials when it is desirable to produce articles having less elastic recovery energy after being deformed in forming processes, such as thermoforming. Also, lightly crosslinked materials tend to accommodate higher degrees of elongation before failing compared to highly crosslinked materials. In some embodiments, non-crosslinked materials are preferred to give very high degrees of elongation without failing. In some embodiments, lightly crosslinked materials are useful over non-crosslinked materials to give better resistance to chemicals and resistance to creep and other dimensional instability over time.

Crosslink density is inversely related to the average molecular weight per crosslink point. The average molecular weight per crosslink point can be calculated using the same general concept as disclosed in U.S. Pat. No. 6,040,044. The equation is:

Average molecular weight per crosslink point=Total weight/number of crosslink points

The total weight was calculated by first calculating the product of (the number of moles)*(the molecular weight) for each component, and then summing the products for each component in the formulation. This may also be written as:

SIGMA(number of moles of each component incorporated×molecular weight of each component)

The number of crosslink points can be calculated as the density of the crosslink points multiplied by the volume of the material. The density of crosslink points can be calculated using the method described in Macromolecules, Vol. 9, No. 2, pages 206-211 (1976). One case involves step-growth copolymerizations with arbitrary functional groups of type A with some molecules having more than two functional groups per molecule and functional groups type B with molecules all having two functional groups per molecule. In this case, the density of crosslink points joining m chains, denoted [Xₘ], can be calculated with the equation:

$$[ {X}_{m} ] = {\sum }_{{f}_{i} = m}^{{f}_{k}} {[ {A}_{{f}_{i}} ]}_{0} P ( {X}_{m , {f}_{i}} )$$

which is equation 49 in the Macromolecules reference. In this equation, t is the degree of functionality of a comonomer, fₖ is the highest functionality in the system, m ranges from 3 to fₖ, [A_{fi}]₀ is the initial concentration of comonomers with functionality fᵢ, and P(X_{m,fi}) is the probability that a monomer of functionality fᵢ acts as a crosslink point for exactly m chains. The total crosslink density, [X], is the sum of all [Xₘ] from m=3 to fₖ. The probability P(X_{m,fi}) can be calculated by the equation:

$$P ( {X}_{m , {f}_{i}} ) = ( \begin{matrix}{f}_{i} \\ m\end{matrix} ) {{P ( {F}_{{A}^{out}} )}^{{f}_{i} - m} [ 1 - P ( {F}_{{A}^{out}} ) ]}^{m}$$

which is equation 45 in the Macromolecules reference, where P(F_{Aout}) is the probability that an arbitrary functional group is not chemically bound to a complementary chemical group attached to an infinite polymer network. This probability can be found by numerically solving the equation:

rp²Σᵢa_{f}_{ᵢ}P(F_{A}_{^{out}})^{f}^{ᵢ}⁻¹−P(F_{A}_{^{out}})−rp²+1=0

which is equation 22 in the Macromolecules reference. In this equation, p is the reaction conversion of the chemical functionalities of type A, r is the molar ratio of functional groups A to functional group B, and a_{f} is the mole fraction of functional groups on molecules with functionality f

Similar equations are taught in the Macromolecules reference that can be used to calculate the number of crosslinking points in other types of chemical systems. These other types of chemical systems include chain addition polymerizations or step-growth copolymerizations involving components having functionality greater than two for two distinct types of functional groups.

It should be noted that these calculations do not account for moisture introduced into the reaction as a contaminant, which can lower the actual crosslink density compared to the calculated expected crosslink density. A slight excess of moles of isocyanate functionality can be added relative to the moles of hydroxyl or amine functionality to account for contaminant moisture. Also, these equations do not account for moisture curing that may occur when excess moles of isocyanate functionality are added relative to the moles of hydroxyl or amine functionality, and this moisture curing can increase the actual crosslink density compared to the expected crosslink density.

In some embodiments, the polymer layer includes resins having low cross link densities. For example, in some embodiments, resins comprising lightly crosslinked material having a molecular weight per crosslink point of greater than about 2,800 g/mol are useful in the present disclosure.

In some embodiments, the present disclosure provides polymer systems, including polyurethane dispersions, 2K urethanes coated from solvent, 100% solids 2K urethanes and 2 layer urethanes. The polymer layer can be formed, for example, out of solution, aqueous dispersion, or 100% solids coating such as via hot melt or extrusion. The polymer layer may be transparent, translucent, or opaque. It may be colored or colorless. The polymer layer may, for example, be clear and colorless or pigmented with opaque, transparent, or translucent dyes and/or pigments. In some embodiments, inclusion of specialty pigments, such as for example metallic flake pigments, can be useful.

The polymer layer is typically formed on the transfer carrier after the transparent microspheres have been partially embedded in the release layer of the transfer carrier. The polymer layer is typically coated over the partially embedded transparent microspheres by a direct coating process but could also be provided over the transparent microspheres via thermal lamination either from a separate carrier or by first forming the compliant article on a separate substrate from which it is subsequently transferred to cover the transparent microspheres.

In some embodiments, the polymer layer includes an aliphatic polyurethane polymer that has a plurality of soft segments, and a plurality of hard segments. The soft segments may include poly(alkoxy) polyol, polycarbonate polyol, or combinations thereof. In some embodiments, the poly(alkoxy) polyol is free of crosslinker. In some embodiments, polycarbonate polyols contain carbonate groups “—O—C(═O)—O—” and hydroxyl functionality. Polycarbonate polyols suitable for the present disclosure include those commercially available from Kuraray in which carbonate groups, 1,6 hexanediol, and 3-methyl, 1,5 pentanediol, make up the polycarbonate diols. 3-methyl 1, 5 pentane diol is also useful as a chain extender in the polymerization of polycarbonate diols with isocyanates to make polycarbonate polyurethanes. In cases where the polycarbonate diols comprise 3-methyl 1, 5 pentane diol, the use of 3-methyl 1, 5 pentane diol can provide a miscible formulation.

In some embodiments, the soft segments have a number average molecular weight of less than 10,000 g/mol. In some embodiments, the hard segments are derived from diols having molecular weights of less than 600 g/mol. In some embodiments, the soft segments have a number average molecular weight of at least 500 g/mol. In some embodiments, the soft segments have a number average molecular weight of 500 g/mol to 6,000 g/mol. In some embodiments, the soft segments have a number average molecular weight of 500 g/mol to 3,000 g/mol. In some embodiments, the compliant article has a thickness of 50 to 600 microns, and includes microspheres having an average diameter of about 30 to 200 microns.

In some embodiments, the aliphatic polyurethane polymer contains less than 50 percent by weight hard segments and 15 to 90 percent by weight soft segments. In some embodiments, the total amount of hard and soft segments in the aliphatic polyurethane polymer is at least 90 percent by weight of the polymer.

In some embodiments, a second additional layer is disposed between the polyurethane layer and the polymer layer.

### First Layer

The first layer can be selected from a variety of materials depending on the desired application. For example, in some embodiments, the first layer may be selected such that the presently disclosed abrasion resistant article is thermoformable, stain resistant, solvent resistant, or a combination thereof.

The first layer is typically a fluorine-containing organic polymeric material. In some embodiments, the transparent microspheres are partially embedded in the first major surface of the first layer and adhered thereto. The first layer should exhibit good adhesion to the transparent microspheres themselves or to the treated microspheres. It is also possible that an adhesion promoter for the microspheres could be added directly to the first layer itself as long as it is compatible within the process window for disposing the first layer on the surfaces of the microspheres. It is important that the first layer has sufficient release from the thermoplastic release layer of the transfer carrier to allow removal of the transfer carrier from the microspheres, which are embedded on one side in the thermoplastic release layer and on the other side in the first layer. In the stain resistant articles of the present disclosure the exposed bead surfaces are not covered by the first layer.

The first layer of the present disclosure is selected such that the resulting articles exhibit stain resistance to yellow mustard at elevated temperature and humidity. For example, in some embodiments, articles made using such first layer exhibit a stain resistance to yellow mustard at elevated temperature and humidity as measured by the change in b* of less than 70, preferably less 50, and most preferably less than 20.

It has been surprisingly found that the fluorine-containing polymer of the first layer be derived in part from at least one partially fluorinated, or non-fluorinated, monomer in order to exhibit the desired stain resistance characteristics. An example of a partially fluorinated component is vinylidene fluoride. It was unexpectedly found that the desired stain resistance properties did not necessarily correspond with those materials having the lowest surface energies.

Such stain resistance characteristics have also unexpectedly been found to be related to the amount and location of the fluorine atoms in the fluorine-containing polymer of the first layer. This may be calculated by taking into account both the weight ratios of the monomers included as well as the fluorine content by weight of each monomer along its polymerizable chain length, including fluorine atoms that are present on those atoms once removed from the polymerizable chain. As an example, a copolymer of tetrafluoroethylene, hexafluoropropylene, and vinylidene fluoride in a weight ratio of 10:40:50 would have a backbone fluorine content of 67.7%. This was calculated as follows.

Tetrafluoroethylene: C2F2, molecular weight 100.01, monomeric fluorine content 76.0%, weight ratio 10%;

Hexafluoropropylene: C3F6, molecular weight 150.02, monomeric fluorine content 76.0%, weight ratio 40%;

Vinylidene fluoride: C2H2F2, molecular weight 64.03, monomeric fluorine content 59.3%, weight ratio 50%.

(0.1×0.76)+(0.4×0.76)+(0.5×0.593)]×100=67.7%.

Note that this calculation includes the fluorine atoms on the trifluoromethyl group of hexafluoropropylene since it is only one atom removed from the polymerizable chain of the hexafluoropropylene monomer.

In some embodiments of the present disclosure the fluorine content along the polymeric backbone of the fluorine-containing polymer is from about 27% to about 72% by weight.

Although there may be fluorine-containing materials which possess the desired fluorine content they may not exhibit the desired level of stain resistance to highly staining materials, such as yellow mustard, at elevated temperature and humidity. Without wishing to be bound by theory, it is believed that those materials in which the fluorine atoms reside solely, or predominately, in pendent side chains or end group do not exhibit the desired stain resistance characteristics of the articles of the present disclosure. While materials in which the fluorine atoms reside solely, or predominately, in pendent side chains or end group may provide adequate stain resistance to yellow mustard at room temperature and humidity they have been found to not do so at elevated temperature and humidity.

The fluorine-containing polymer of the first layer is desirably coatable out of solvent or from an aqueous dispersion. Use of solvent coating or aqueous dispersions provides advantages such as lower processing temperatures which in turn permits the use of materials such as polyethylene in the transfer carrier. Lower process temperatures also generally result in decreased thermal stress in the final articles. In addition, the use of certain higher boiling solvents may advantageously provide articles with reduced amounts of entrapped air in the dried and cured first layer.

In addition to being coatable from solvent or aqueous dispersions, the fluorine-containing materials of the first layer desirably form a continuous film upon drying. Without being bound by theory, it is believed that film continuity, i.e., free of pinholes and other discontinuities, contributes to the resistance of the articles of the present disclosure to highly staining materials such as yellow mustard, blood, wine, etc. It is also believed that such film continuity contributes to enhanced mechanical properties as well as improving bead transfer from the transfer carrier to the first layer.

It was also surprisingly found that for some embodiments of the present disclosure it was not necessary to employ a surface treatment prior to providing an optional reinforcing layer. Typically fluoropolymers are surface treated prior to bonding them to other materials. Such treatments include plasma, corona, and chemical etching, eg, sodium etch.

Materials useful in the first layer include fluorine-containing polymers including, but not limited, to those selected from at least one of the following: fluoroolefins and fluorourethanes. Fluoroolefins include elastomeric fluoroolefin polymers, thermoplastic fluoroolefin polymers, elastomeric fluoroolefin polymers crosslinked with multifunctional acrylates or multifunctional amines, and thermoplastic fluoroolefin polymers crosslinked with multifunctional amines. Fluorourethanes include crosslinked fluorinated polyurethanes. Any combination of these materials may also be used so long as they are miscible in one another.

Examples of useful elastomeric fluoroolefin polymers include, but are not limited to, bromine-containing copolymers of tetrafluoroethylene, hexafluoropropylene, and vinylidene fluoride such as that available under the trade designation “3M DYNEON PEROXIDE CURE FLUOROELASTOMER FPO 3740” from 3M Company, St. Paul, Minn.; and ultra-low viscosity fluoropolymers such as that obtained as an experimental or developmental product under the trade designation “3M DYNEON FLUOROELASTOMER E-20575” from 3M Company, St. Paul, Minn. Examples of useful thermoplastic fluoroolefin polymers include, but are not limited to, copolymers of tetrafluoroethylene, hexafluoropropylene, and vinylidene fluoride such as that available under the trade designation “3M DYNAMAR POLYMER PROCESSING ADDITIVE FX 5912” from 3M Company, St. Paul, Minn. Examples of useful co-crosslinked fluoropolymers include, but are not limited to, elastomeric fluoroolefins co-reacted with multifunctional acrylates, such as pentaerythritol triacrylate, available under the trade designation SARTOMER SR 344 from Sartomer USA, LLC, Exton, Pa., and trimethylolpropane triacrylate, available under the trade designation SARTOMER SR 351H from Sartomer USA, LLC, Exton, Pa. may also be used. Examples of useful fluoropolymers crosslinked with amines include, but are not limited to, thermoplastic fluoroolefins reacted with multifunctional primary amines such as that available under the trade designation JEFFAMINE T403 from Huntsman Corporation, The Woodlands, Tex., and polyetherimines such as that obtained under the code number 32034100 from ACROS Organics, a subsidiary of Thermo Fisher Scientific, Minneapolis, Minn. A useful, non-limiting, example of a fluorourethane is that derived from the reaction of a polyfunctional, aliphatic isocyanate resin based hexamethylene diisocyanate (HDI), such as that available under the trade designation DESMODUR N3300A from Bayer Materials Science LLC, Pittsburgh, Pa. and a fluorinated polyhydroxy-containing polymer such as that available under the trade designation ZEFFLE GK 570 from Daikin America, Orangeburg, N.Y.

CN 101314684 and CN 101319113, for example, disclose ZEFFLE GK 570 as having a fluorine content of 35-40%. JP 2010182862, for example, discloses ZEFFLE GK 570 as having a fluorine content of 35%. The forgoing documents are incorporated herein by reference in their entirety.

For the presently disclosed articles to be stain resistant and thermoformable, it is preferred that the first layers are not crosslinked or are very lightly crosslinked. Lightly crosslinked materials are preferred over highly crosslinked materials because they produce less elastic recovery energy after being deformed in the forming process. Also, lightly crosslinked materials tend to accommodate higher degrees of elongation before failing compared to highly crosslinked materials. In some embodiments, non-crosslinked materials are preferred to give very high degrees of elongation without failing. In some embodiments, lightly crosslinked materials are preferred over non-crosslinked materials to give better resistance to chemicals as well as resistance to creep and other dimensional instability over time.

The first layer may be transparent, translucent, or opaque. The first layer may, for example, be clear and colorless or pigmented with opaque, transparent, or translucent dyes and/or pigments. In some embodiments, inclusion of specialty pigments, such as for example metallic flake pigments, can be useful.

The first layer is typically formed on the transfer carrier after the transparent microspheres have been partially embedded in the release layer of the transfer carrier. The first layer is typically coated over the partially embedded transparent microspheres by a direct coating process but could also be provided over the transparent microspheres via thermal lamination either from a separate carrier or by first forming the first layer on a separate substrate from which it is subsequently transferred to cover the transparent microspheres.

In the presently disclosed transfer and microsphere coated articles, the plurality of transparent microspheres are typically disposed on the first major surface of the first layer to provide sufficient pencil hardness and abrasion characteristics.

In some embodiments the first layer is continuous such that there is no break either in the areas between, or beneath, the microspheres in the stain resistant articles of the disclosure. In another embodiment, the first layer is continuous in the areas between the microspheres, although it may not be present beneath the microspheres in the stain resistant articles of the present disclosure. In the latter embodiment the microspheres themselves are providing the desired stain resistant characteristics where the first layer is absent.

In some embodiments, materials useful in the first layer include, but are not limited to those selected from at least one of the following linear materials: polyurethanes, polyureas, polyurethane ureas, polyesters, polycarbonate, ABS, polyolefins, acrylic and methacrylic acid ester polymers and copolymers, polyvinyl chloride polymers and copolymers, polyvinyl acetate polymers and copolymers, polyamide polymers and copolymers, fluorine containing polymers and copolymers, silicones, silicone containing copolymers, thermoplastic elastomers, such as neoprene, acrylonitrile butadiene copolymers, and combinations thereof. In some embodiments, polymer matrix composites can be used in the polymer layer. For example, the polymer matrix composites may include nanoparticles in resins, fibers in resins, and the like. Combinations can include any combinations of materials, such as interpenetrating networks, dual cure systems, and the like.

### Substrate Layers

The presently disclosed microsphere coated articles and transfer articles can optionally comprise one or more substrate layer(s). Examples of suitable substrate layers include but are not limited to those selected from at least one of fabrics (including synthetics, non-synthetics, woven and non-woven such as nylon, polyester, etc.), polymer coated fabrics such as vinyl coated fabrics, polyurethane coated fabrics, etc.; leather; metal; paint coated metal; paper; polymeric films or sheets such as polyethylene terephthalate, acrylics, polycarbonate, polyurethane, elastomers such as natural and synthetic rubber, and the like; and open-cell foams and closed cell foams, including for example, polyurethane foam, polyethylene foam, foamed rubber, and the like. The substrates may, for example, be in the form of a clothing article or footwear; automobile, marine, or other vehicle seat coverings; automobile, marine, or other vehicle bodies; orthopedic devices; electronic devices (including, for example, flexible electronics and flexible displays), hand held devices, household appliances; sporting goods; and the like.

In the presently disclosed transfer and microsphere coated articles, the plurality of transparent microspheres are typically provided as a continuous layer in some embodiments or as a discontinuous layer in some embodiments. The compliant article is continuous in some embodiments or discontinuous in some embodiments. The substrate adhesive, when present, may be continuous in some embodiments or discontinuous in some embodiments. Typically, the substrate layer, when present, is continuous, although it may be discontinuous. In the presently disclosed microsphere coated articles all layers can optionally be continuous or discontinuous.

In some embodiments, where the article is bonded to a substrate layer, the presently disclosed article can be thermally bonded to various substrates without distortion of or other defects in the article.

### Graphic Layer Options

The presently disclosed compliant article can optionally also perform the function of acting as the adhesive for a desired substrate and/or further comprise pigment(s) such that it also has a graphic function.

The compliant article, when selected to function also as a substrate adhesive, may be, for example, pigmented and provided in the form of an image, such as, for example, by screen printing the adhesive in the form of a graphic for transfer to a separate substrate. However, the compliant article, in some instances, is preferably colorless and transparent so that it can allow transmission of color from either a substrate, separate graphic layers (discontinuous colored polymeric layers) placed below it, or from a separate substrate adhesive that is optionally colored and optionally printed in the form of a graphic image (a discontinuous layer).

Typically, if a graphic image is desired it is provided separately on the surface of the compliant article opposite the plurality of transparent microspheres by at least one colored polymeric layer. The optional colored polymeric layer may, for example, comprise an ink. Examples of suitable inks for use in the present disclosure include but are not limited to those selected from at least one of pigmented vinyl polymers and vinyl copolymers, acrylic and methacrylic copolymers, urethane polymers and copolymers, copolymers of ethylene with acrylic acid, methacrylic acid and their metallic salts, and blends thereof. The colored polymeric layer, which can be an ink, can be printed via a range of methods including, but not limited to screen printing, flexographic printing, offset printing, lithography, transfer electrophotography, transfer foil, and direct or transfer xerography. The colored polymeric layer may be transparent, opaque, or translucent.

A colored polymeric layer(s) may be included in the articles of the present disclosure by a number of procedures. For example, a transfer carrier can have a layer of transparent microspheres embedded in the release layer thereof, following which the microsphere embedded surface of the release layer is coated with a transparent layer of a compliant article. This microsphere and adhesive coated transfer carrier can function as a casting liner by coating, for example, a continuous colored plasticized vinyl layer over the compliant article and wet laminating a woven or non-woven fabric thereover.

Another method involves providing graphic layers (discontinuous colored polymeric layers, for example) on the compliant article prior to casting a continuous colored plasticized vinyl layer to approximate the image of leather, for example.

### Optional Adhesive Layer(s)

The presently disclosed article and transfer article may each optionally further comprise one or more adhesive layers. A substrate adhesive layer, for example, may optionally be included in the article in order to provide a means for bonding the compliant article or the layer(s) of material optionally bonded to the compliant article to a substrate. These optional adhesive layer(s) may be optionally present when, for example, the compliant article cannot function also as an adhesive for a desired substrate. A substrate adhesive layer (as well as any other optional adhesive layers) may comprise the same general types of polymeric materials used for the compliant article and may be applied following the same general procedures. However, each adhesive layer used must be selected such that it will adhere the desired layers together. For example, a substrate adhesive layer must be selected such that it can adhere to an intended substrate as well as to the other layer to which it is bonded.

### Reinforcing Layer(s)

Optional layers may be included in the presently disclosed article and transfer article to, for example, enhance the ability to separate the transfer carrier from the layer of a plurality of transparent microspheres. Such an optional layer which in such an article can function as a reinforcing layer would typically be positioned in between the plurality of microspheres and a substrate adhesive layer. Examples of useful reinforcing layers would include additional substrate layer(s), for example.

A microsphere coated and adhesive coated transfer carrier could be coated with a fabric adhesive such as a polyester, or a polyamide, followed by lamination to a woven fabric or to a moisture transmitting membrane, to function as a slippery liner for clothing, for example.

### Embossing

The articles of the present disclosure may optionally be embossed. The embossing procedure would typically involve subjecting the article, bonded to an embossable substrate, and with the transfer carrier removed, to heat and pressure such as by a heated patterned roller assembly or a patterned heated platen press. For embossed articles it is preferable that the compliant article not be melted during the embossing operation, to preserve the microsphere embedment level, while at the same time flexible enough to be deformed without cracking. Another method of embossing would be to thermally laminate the transfer article to an irregular substrate such as, for example a coarse fabric such that after the transfer carrier is removed, that the surface is conformed to the irregular layer below it. In some embodiments, thermoforming can be used when processing the presently disclosed articles and transfer articles.

For some applications, it can be desirable to obtain specific bead surface area coverage. In some embodiments, at least about 40% of an outer surface of the article is covered with the plurality of microspheres. In some embodiments, at least about 60% of an outer surface of the article is covered with the plurality of microspheres. In some embodiments, the article has at least a portion of a first major surface covered with the plurality of microspheres with coverage greater than or equal to 30% of that portion of the first major surface. In some embodiments, the article has at least a portion of a first major surface covered with the plurality of microspheres with coverage less than or equal to 50% of that portion of the first major surface. In some embodiments, the percent of area covered by microspheres in one area of the film can be one coverage density, such as about 71%. In some embodiments, the percent of area covered by microspheres in another area of the film can be the same or different coverage density, such as 47%. In some embodiments, the percent of area covered by microspheres in yet another area of the film can be the same or different coverage density, such as 44%. In some embodiments, the presently disclosed articles include a plurality of microspheres that are substantially uniformly spaced.

In some embodiments, the presently disclosed articles can have additional layers, such as for example, a second layer. In some embodiments the second layer is or includes a flexible material.

In some embodiments, the articles are resistant to organic solvents, such as that used in the Solvent Resistance test method included in the Examples section below. In some embodiments, the article exhibits a coefficient of friction of less than or equal to 0.35, preferably less than or equal to 0.3, and more preferably less than or equal to 0.25. In some embodiments, the article is heat bonded at elevated temperatures to a substrate. In some embodiments, any of the previously disclosed articles have a gloss change at 85° Angle of less than or equal to 1.00 according the Abrasion Resistance Test, preferably a gloss change at 85° Angle of less than or equal to 0.40 according the Abrasion Resistance Test, and more preferably a gloss change at 85° Angle of less than or equal to 0.15 according the Abrasion Resistance Test.

A non-limiting list of exemplary embodiments and combinations of exemplary embodiments of the present disclosure are disclosed below:

### Embodiment 1

An article comprising: (a) a compliant article wherein the compliant article comprises a polymer layer and a first layer disposed along a first major surface of the polymer layer; and (b) a plurality of microspheres partially embedded and adhered to a major surface of the first layer opposite the surface that is disposed along the first major surface of the polymer layer, wherein the article has a compression modulus of less than or equal to 0.5 MPa.

### Embodiment 2

The article of Embodiment 1 wherein the first layer is selected such that the article exhibits a stain resistance to yellow mustard at elevated temperature and humidity as measured by the change in b* of less than 70.

### Embodiment 3

The article of Embodiments 1 or 2, wherein the thickness of the compliant article is greater than 50 microns.

### Embodiment 4

The article of any of the preceding Embodiments, wherein the first layer is selected from at least one of linear resins and resins having low cross link densities.

### Embodiment 5

The article of claim 4, wherein the linear resins are selected from at least one of the following linear materials: polyurethanes, polyureas, polyurethane ureas, polypolyesters, polycarbonate, ABS, polyolefins, acrylic and methacrylic acid ester polymers and copolymers, polyvinyl chloride polymers and copolymers, polyvinyl acetate polymers and copolymers, polyamide polymers and copolymers, fluorine containing polymers and copolymers, silicones, silicone containing copolymers, thermoplastic elastomers, such as neoprene, acrylonitrile butadiene copolymers, and combinations thereof.

### Embodiment 6

The article of Embodiment 4 or 5 wherein the article has an elongation percent at failure of greater than 26%.

### Embodiment 7

The article of any of the preceding Embodiments wherein the plurality of microspheres are selected from at least one of glass, polymers, glass ceramics, ceramics, metals and combinations thereof.

### Embodiment 8

The article of any of the preceding Embodiments further comprising a second layer disposed along the second major surface of the compliant article.

### Embodiment 9

The article of Embodiment 8 wherein the second layer comprises a flexible material.

### Embodiment 10

The article of any of the preceding Embodiments wherein the article is resistant to organic solvents.

### Embodiment 11

The article of any of the preceding Embodiments wherein the article exhibits a coefficient of friction of less than or equal to 0.3.

### Embodiment 12

The article of any of the preceding Embodiments wherein the article is heat bonded at elevated temperatures to a substrate.

### Embodiment 13

The article of any of the preceding Embodiments wherein the polymer layer comprises an aliphatic polyurethane polymer comprising a plurality of soft segments, and a plurality of hard segments, wherein the soft segments comprise poly(alkoxy) polyol, polycarbonate polyol, or combinations thereof, wherein the soft segment is essentially free of crosslinker.

### Embodiment 14

The article of Embodiment 13 wherein the soft segments have a number average molecular weight of less than 10,000 g/mol, and wherein the hard segments are derived from diols having molecular weights of less than 600 g/mol.

### Embodiment 15

The article of Embodiment 13 or 14 wherein the soft segments have a number average molecular weight of at least 500 g/mol.

### Embodiment 16

The article of any of Embodiments 13 to 15 wherein the soft segments have a number average molecular weight of 500 g/mol to 6,000 g/mol.

### Embodiment 17

The article of any of Embodiments 13 to 16 wherein the soft segments have a number average molecular weight of 500 g/mol to 3,000 g/mol.

### Embodiment 18

The article of any Embodiments 13 to 17 wherein the compliant article has a thickness of 50 to 600 microns, and includes microspheres having an average diameter of about 30 to 200 microns.

### Embodiment 19

The article of any Embodiments 13 to 18 wherein the aliphatic polyurethane polymer contains less than 50 percent by weight hard segments and 15 to 90 percent by weight soft segments.

### Embodiment 20

The article of any of Embodiments 13 to 19 wherein the total amount of hard and soft segments in the aliphatic polyurethane polymer is at least 90 percent by weight of the polymer.

### Embodiment 21

The article of any of the preceding Embodiments further comprising at least one additional layer disposed between the first layer and the polymer layer.

### Embodiment 22

The article of any of Embodiment 21 further comprising a second additional layer disposed between the polyurethane layer and the polymer layer.

### Embodiment 23

An article having a compliant article wherein the compliant article comprises a polymer layer; and a plurality of microspheres partially embedded and adhered to a major surface of the compliant article, where the article has a compression modulus of less than or equal to 0.5 MPa, and further wherein the article is a decorative article.

### Embodiment 24

The article of Embodiment 23 wherein the compliant article further comprises a first layer disposed between the polymer layer and the plurality of microspheres.

### Embodiment 25

The article of Embodiment 24 wherein the first layer is selected such that the article exhibits a stain resistance to yellow mustard at elevated temperature and humidity as measured by the change in b* of less than 70.

### Embodiment 26

The article of any of Embodiments 23 to 25, wherein the thickness of the compliant article is greater than 50 microns.

### Embodiment 27

The article of Embodiment 24 wherein the first layer is selected from at least one of linear resins and resins having low cross link densities.

### Embodiment 28

The article of Embodiment 27, wherein the linear resins are selected from at least one of the following linear materials: polyurethanes, polyureas, polyurethane ureas, polypolyesters, polycarbonate, ABS, polyolefins, acrylic and methacrylic acid ester polymers and copolymers, polyvinyl chloride polymers and copolymers, polyvinyl acetate polymers and copolymers, polyamide polymers and copolymers, fluorine containing polymers and copolymers, silicones, silicone containing copolymers, thermoplastic elastomers, such as neoprene, acrylonitrile butadiene copolymers, and combinations thereof.

### Embodiment 29

The article of Embodiment 27 or 28 wherein the article has an elongation percent at failure of greater than 26%.

### Embodiment 30

The article of any of Embodiments 23 to 29 wherein the plurality of microspheres are selected from at least one of glass, polymers, glass ceramics, ceramics, metals and combinations thereof.

### Embodiment 31

The article of any of Embodiments 23 to 30 further comprising a second layer disposed along the second major surface of the compliant article.

### Embodiment 32

The article of any of Embodiments 23 to 31 wherein the second layer comprises a flexible material.

### Embodiment 33

The article of any of Embodiments 23 to 32 wherein the article is resistant to organic solvents.

### Embodiment 34

The article of any of Embodiments 23 to 33 wherein the article exhibits a coefficient of friction of less than or equal to 0.3.

### Embodiment 35

The article of any of Embodiments 23 to 34 wherein the article is heat bonded at elevated temperatures to a substrate.

### Embodiment 36

The article of any of Embodiments 23 to 35 wherein the polymer layer comprises an aliphatic polyurethane polymer comprising a plurality of soft segments, and a plurality of hard segments, wherein the soft segments comprise poly(alkoxy) polyol, polycarbonate polyol, or combinations thereof, and wherein the soft segment is essentially free of crosslinker.

### Embodiment 37

The article of Embodiment 36 wherein the soft segments have a number average molecular weight of less than 10,000 g/mol, and wherein the hard segments are derived from diols having molecular weights of less than 600 g/mol.

### Embodiment 38

The article of Embodiment 36 or 37 wherein the soft segments have a number average molecular weight of at least 500 g/mol.

### Embodiment 39

The article of any of Embodiments 36 to 38 wherein the soft segments have a number average molecular weight of 500 g/mol to 6,000 g/mol.

### Embodiment 40

The article of any of Embodiments 36 to 39 wherein the soft segments have a number average molecular weight of 500 g/mol to 3,000 g/mol.

### Embodiment 41

The article of any Embodiments 36 to 40 wherein the polymer layer has a thickness of 50 to 600 microns, and includes microspheres having an average diameter of about 30 to 200 microns.

### Embodiment 42

The article of any Embodiments 36 to 41 wherein the polyurethane polymer contains less than 50 percent by weight hard segments and 15 to 90 percent by weight soft segments.

### Embodiment 43

The article of any of Embodiments 36 to 42 wherein the total amount of hard and soft segments in the polyurethane polymer is at least 90 percent by weight of the polymer.

### Embodiment 44

The article of any of Embodiments 1 to 22 wherein the article has a gloss change at 85° Angle of less than or equal to 1.00 according the Abrasion Resistance Test.

### Embodiment 45

The article of any of Embodiments 23 to 43 wherein the article has a gloss change at 85° Angle of less than or equal to 1.00 according the Abrasion Resistance Test.

Various modifications and alterations of this invention will become apparent to those skilled in the art without departing from the scope and spirit of this invention.

### EXAMPLES

### Materials

| Designation | Description |
|---|---|
| FP1 | A free-flowing, granular, fluorothermoplastic processing |
| | aid having a melting point of 110-126° C. and based |
| | on a terpolymer of tetrafluoroethylene, |
| | hexafluoropropylene, and vinylidene fluoride, available |
| | under the trade designation 3M DYNAMAR Polymer |
| | Processing Additive FX 5912 from 3M Company, St. |
| | Paul, MN. |
| FP2 | A free-flowing, granular, fluoropolymer processing aid |
| | having a melting point of 110-126° C. and based on |
| | a terpolymer of tetrafluoroethylene, hexafluoropropylene, |
| | and vinylidene fluoride, available under the trade |
| | designation 3M DYNAMAR Polymer Processing Additive |
| | FX 5911 from 3M Company, St. Paul, MN. |
| Amine 1 | A trifunctional, primary amine based on repeating |
| | oxypropylene units in the backbone, with an average |
| | molecular weight of about 440, a total amine content |
| | of 6.1 to 6.6 meq/gram and having primary amine groups |
| | located on secondary carbon atoms at the end of |
| | the aliphatic polyether chain, available under the |
| | trade designation JEFFAMINE T403 from Huntsman |
| | Corporation, The Woodlands, TX. |
| ICN 1 | A liquid cycloaliphatic diisocyanate, dicyclohexylmethane |
| | diisocyanate, having an equivalent weight of 132 |
| | maximum, an NCO content of 31.8% minimum, and a |
| | solidification point of 25° C., available under the |
| | trade designation DESMODUR W from Bayer |
| | MaterialScience LLC, Pittsburgh, PA. |
| ICN 2 | A solvent free, polyfunctional, aliphatic isocyanate resin |
| | based hexamethylene diisocyanate (HDI) having an |
| | equivalent weight of approximately 193, an NCO content of |
| | 21.8%, and a monomeric HDI content of 0.2% maximum, |
| | available under the trade designation DESMODUR |
| | N3300A from Bayer MaterialScience LLC, Pittsburgh, PA. |
| POH 1 | A liquid aliphatic polyester polyol, having a hydroxyl |
| | number of 230 and a hydroxyl equivalent weight of 244, |
| | available under the trade designation K-FLEX 188 from |
| | King Industries Specialty Chemicals, Norwalk, CT. |
| POH 2 | Polytetramethylene ether glycol, a waxy solid having a |
| | molecular weight of 625-675, a hydroxyl number of |
| | 166-180, and a melting point of 11-19° C., available |
| | under the trade designation TERATHANE 650 from |
| | Invista, Wichita, KS. |
| POH 3 | A liquid diol having a molecular weight of 90 and a boiling |
| | point of 23° C., available as 1,4-butanediol from Chemtura |
| | Corporation, Middlebury, CT. |
| FPOH 1 | A 65% solids solution in n-butyl acetate of a copolymer of |
| | tetrafluoroethylene and vinyl monomers, having a hydroxyl |
| | value of 55-65 mg KOH/gram resin which is suitable for |
| | reaction with isocyanates, available under the trade |
| | designation ZEFFLE GK 570 from Daikin America, |
| | Orangeburg, NY. This is believed to contain 35-40% |
| | fluorine by weight. |
| POH 4 | 3-methyl-1,5 pentanediol, available as MPD from Kuraray |
| | America, New York, NY. |
| POH 5 | A liquid polycarbonate polyol based on 3-methyl-1,5 |
| | pentanediol and 1,6 hexanediol (9:1) with a molecular |
| | weight of 2000 and an OH value of 56, available as |
| | Kuraray Polyol C2090 from Kuraray America, New |
| | York, NY. |
| T12 | Dibutyltin dilaurate (DBTDL), a liquid catalyst, available |
| | under the trade designation DABCO T-12 from Air |
| | Products and Chemicals, Incorporated, Allentown, PA. |
| CAT 1 | Polyurethane catalyst available under the trade designation |
| | POLYCAT 8 from Air Products and Chemicals, |
| | Incorporated, Allentown, PA. |
| MEK | methyl ethyl ketone |
| MIBK | methyl isobutyl ketone |
| EtOAc | ethyl acetate |
| Borosilicate | Type 1 borosilicate glass microsphere beads having an |
| glass | average size in the range of 38-75 micrometers, a |
| microspheres | refractive index of 1.47 as determined by the standard |
| | Becke line method, and a density of 2.23 g/cc, obtained |
| | from Mo Sci Incorporated, Rolla, MO. |
| Borosilicate | Milled borosilicate glass powder having a size distribution |
| glass powder | of less than 200 mesh and density of 2.23 g/cc, available |
| | as PYREX 7740 from Strategic Materials Incorporated, |
| | Houston TX. |
| Soda lime | Silane treated soda lime silicate microsphere beads having |
| silicate | an average size in the range of 44-53 micrometers, a |
| microspheres | refractive index of 1.52 as determined by the standard |
| | Becke line method, and a density of 2.52 g/cc, obtained |
| | from Swarco Industries, Incorporated, Columbia, TN. |
| PC/PBT | An extrusion film having a nominal thickness of 0.18 mm |
| | (0.007 inches) based on MAKROLON (PC)/Polyester |
| | (PBT) blend, available under the trade designation |
| | BAYFOL CR 6-2 from Bayer MaterialScience LLC, |
| | Pittsburgh, PA. |
| water | Deionized water |
| SI1 | A dimethylpolysiloxane having a viscosity of 50 centiPoise |
| | (50 milliPascals), available under the trade designation |
| | PST-850 from PolySi Technologies, Sanford, NC. |
| SI2 | A carbinol (hydroxyl) terminated polydimethylsiloxane |
| | having a viscosity of 50-65 centiPoise (50-65 milliPascals), |
| | available under the trade designation DMS-C16 from Gelest |
| | Incorporated, Morrisvillle, PA. |
| IPA | isopropyl alcohol |
| TAIC | triallyl isocyanurate |
| A1100 | gamma-Aminopropyltrimethoxysilane, a clear liquid |
| | coupling agent available under the trade designation |
| | SILQUEST A1100 from Momentive Performance |
| | Materials Incorporated, Columbus, OH. |
| PET 1 | 2 mil clear polyester film chemically treated to improve |
| | adhesion available under the trade designation |
| | HOSTAPHAN 3SAB from Mitsubishi Plastics, Inc., |
| | Tokyo, Japan |
| TPU | A translucent, polyester thermoplastic polyurethane (TPU) |
| | hot melt adhesive having a nominal thickness of 0.10 |
| | millimeters (0.004 inches), a Shore A Hardness of 70, a |
| | melting point of 86° C. (187° F.) and a glass transition |
| | temperature (Tg) of −30° C. (−20° F.), available |
| | under the trade designation ESTANE UB 410B TPU from |
| | Lubrizol Advanced Materials, Cleveland, OH. |
| SILQUEST | Gamma-Aminopropyltrimethoxysilane, a clear liquid |
| A1100 | coupling agent, sold under the trade designation |
| | “SILQUEST A1100” from Momentive Performance |
| | Materials Incorporated, Columbus, OH. |

### Test Methods

### Compression Modulus (E′)

Articles were evaluated for compression modulus. The modulus, measured in compression and referred to hereinafter as compression modulus was obtained by placing a sample disk having a diameter of 25 millimeters (1 inch) and a thickness of 0.2 to 3.8 millimeters (0.008 to 0.15 inches) in compression at 23° C. (73° F.) between the parallel plates with a normal force of 100 grams using an RSA-2 Solids Analyzer (Rheometrics Scientific, Inc, Piscataway, N.J.), a frequency of 1 Hz (6.28 rad/sec), a strain of 0.2%, and measuring the stress response of the sample. The compression modulus results were reported in MegaPascals (MPa).

### Retroreflectivity Test

Measurements of the coefficient of retroreflection (Ra) were made directly on the beaded surface of various constructions according to the procedure established in Procedure B of ASTM Standard E 809-94a, measured at an entrance angle of −4.0 degrees and an observation angle of 1 degree. The photometer used for those measurements is described in U.S. Defensive Publication No. T987,003. Ra was reported in Candelas/square meter/lux. Retroeflective articles typically exhibit a coefficient of retroreflection of more than 2.

### Abrasion Resistance Test

The gloss characteristics of the articles of the invention were evaluated before and after abrasion to determine resistance to abrasion. The initial gloss of the exposed beaded surface of the samples was measured at an angle of 85° using a micro-TRI-gloss meter (manufactured by BYK-Gardner Incorporated, Silver Spring, Md.). Two samples were evaluated. Next, samples were attached to a sliding specimen platform using double coated pressure sensitive adhesive tape such that the beaded surface was exposed for abrasion testing. A 25 millimeter (1 inch) disc of abrasive paper (available under the trade designation “3M WETORDRY SHEET P320 GRIT”; an aluminum oxide based sanding paper, available from 3M Company, St. Paul, Minn.) was attached to the circular tool holder at the end of the test arm using double coated pressure sensitive adhesive tape. The tool holder was then gently lowered to the surface of the beaded surface of the sample, adjusted to ensure the test arm was parallel to the sample surface, and a 5 N load put in place. The sliding specimen platform was moved in a horizontal, reciprocating motion under the tool holder for 75 cycles at a speed of 25 cycles/minute. The stroke length was 3.8 centimeters (1.5 inches). Next, the sample was removed and its' surface wiped clean with a microfiber cloth moistened with isopropyl alcohol. The cleaned surface was then evaluated again for gloss at an angle of 85°. The average values of initial and abraded gloss (which are unitless) were used to determine the change in gloss which was recorded. A lower gloss change was indicative of greater abrasion resistance.

Some of the abraded and unabraded samples were also evaluated by scanning electron microscopy (SEM) to evaluate abrasion resistance. Those samples having instances of broken off bead tops after abrasion typically exhibited greater changes in gloss values.

### Stain Resistance—Mustard

Articles were labeled and provided with a circle having diameter of 5.08 centimeters (2 inches) on their backside (i.e., opposite the exposed bead surface) using a permanent marking pen. A sheet of white bond paper was placed under the sample and a Hunter Labs MiniScan EZ spectrophotometer (Model #4500L, Hunter Associates Laboratory, Incorporated, Reston, Va.) was used to measure the L*, a*, and b* in the center of the circle from the frontside (i.e., surface having the exposed beads) of the film or laminate. Next, French's 100% Natural Classic Yellow Mustard was applied and uniformly distributed on the frontside of the film within the boundary of the circle using a cotton swab. Samples prepared in this manner were placed in a heat and humidity chamber at a temperature of 66° C. (150° F.) and a relative humidity of 85% for a time of 72 hours. Upon removal from the chamber the films were rinsed with warm water and wiped with a paper towel to remove the remaining material from the test surface. Care was taken not to rupture the film during this process. After drying, L*, a*, and b* were measured as before and the change in the b* value was reported. The b* parameter was selected since it is a measure of the blue-yellow as defined in the CIE (International Commission on Illumination) 1976 Color Space. Values of 50 or less, or 30 or less, or even 20 or less are desirable.

### Solvent Resistance

Articles were evaluated by applying an acetone wet cotton swab onto the beaded surface and moving in a circular motion until the surface was dry. This procedure was repeated until either beads were observed to detach from the film surface or ten repetitions were completed without bead loss. The number of repetitions was recorded until bead failure was observed or ten repetitions were completed without bead failure. The number of repetitions it took to observe bead failure was reported, or a grade of “Pass” was assigned if ten repetitions were completed without bead failure.

### Tensile Elongation

Ultimate strain (elongation at failure) was measured at 23° C. (73° F.) according to ASTM D882-10: “Standard Test Method for Tensile Properties of Thin Plastic Sheeting” using the following parameters. Three straight section specimens measuring 25.4 millimeters (1 inch) wide and 100 millimeters (4 inches) long, were cut from film samples and conditioned for a minimum of 15 minutes at 22+/−2° C. (72° F.) prior to testing. The separation distance between parallel rubber covered grips was 50.8 millimeters (2 inches), and the crosshead speed was 50.8 millimeters/minute (2 inches/minute). The separation rate, force measurements, and data calculations were carried out by the system controller.

### Coefficient of Friction Testing

Articles were evaluated for coefficient of friction using a table top peel tester. A 3.2 millimeter (0.013 inch) thick elastomeric foam having a density of about 0.25 grams/cubic centimeter was bonded to a flat steel substrate measuring 63.5 millimeters (2.5 inches) square, having a thickness of about 6 millimeters (0.024 inches), and weighing approximately 200 grams including the foam. Next, a free-standing bead film having a length of 63.5 millimeters (2.5 inches) that was approximately 5 millimeters longer than the substrate was place over the foam covered surface of the substrate such that the film was wrapped around the leading edge of the substrate. A hole was cut in the film to accommodate the pin by which the substrate was pulled during testing. This test article was placed with the film side down on an isopropyl alcohol wiped glass surface measuring at least 15.2 centimeters by 25.4 centimeters (6 inches by 10 inches). A table top peel tester was used in the coefficient of friction mode to pull the test article across the glass surface at a rate of about 2.29 meters/minute (90 inches/minute) for at least about five seconds. The transducer was calibrated with the force from the weight of the steel substrate with foam as 1.00. In this way pulling forces were directly read out as coefficient of friction (COF). The dynamic (kinetic) coefficient of friction was determined by evaluating the graph of the COF values beginning one second after the start of the measurement. Data was collected at a rate of ten readings/second and the average was recorded. Three samples were run for each film and the average of these three coefficient of friction measurements was reported.

### Method for Making Bead Carrier

### Borosilicate Bead Carrier 1

Borosilicate glass microsphere beads, from Mo Sci Incorporated, Rolla, Mo., were flame treated by passing them through a hydrogen/oxygen flame at a rate of 3 grams/minute and collected in a stainless steel container whereupon metallic impurities were removed using a magnet. The resulting glass microspheres were treated with 600 ppm of Silquest A1100 in the following manner. The silane was dissolved in water, then added to the microsphere beads with mixing, air dried overnight, followed by drying at 110° C. for 20 minutes. The dried, silane treated microsphere beads were then sieved to remove any agglomerates and provide beads having a size of 75 micrometers or less and were free flowing. The resulting transparent silane treated microspheres were cascade coated using a mechanical sifter onto a transfer carrier comprising a polyethylene coated paper substrate which had been preheated to about 140° C. (284° F.), to form a bead carrier having a uniform layer of transparent microspheres embedded in the polyethylene layer to a depth corresponding to about 30-40% of their diameter as determined by a magnifying imaging system.

### Borosilicate Bead Carrier 2

A bead carrier having a uniform layer of transparent microsphere beads embedded in the polyethylene layer to a depth corresponding to about 30% to 40% of their diameter was prepared as described above for Borosilicate Bead Carrier 1 with the following modifications. Borosilicate glass powder, from Strategic Materials Incorporated, Houston, Tex., was passed through the flame treatment twice before removing metallic impurities.

### Soda Lime Silicate Bead Carrier

Soda lime silicate microsphere beads were used as received to prepare a bead carrier in the following manner. The glass microsphere beads were treated with 600 ppm of Silquest A1100 in the following manner. The silane was dissolved in water, then added to the microsphere beads with mixing, air dried overnight, followed by drying at 110° C. for 20 minutes. The dried, silane treated microsphere beads were then sieved to remove any agglomerates and provide beads having a size of 75 micrometers or less and were free flowing. The resulting transparent silane treated microspheres were cascade coated using a mechanical sifter onto a transfer carrier comprising a polyethylene coated paper polyester film liner which had been preheated to about 140° C. (284° F.), to form a bead carrier having a uniform layer of transparent microspheres embedded in the polyethylene layer to a depth corresponding to about 30-40% of their diameter as determined by a magnifying imaging system.

### Comparative Example 1

Part A: To 12.7 kilograms of a solution of FPOH 1 was added 2.3 kilograms EtOAc and 3.06 grams of T12 (300 ppm in the final dried polyurethane resin) to give a 55% solids (w/w) FPOH 1/T12 solution. A 50% solids (w/w) solution of ICN 2 in EtOAc was also prepared. The FPOH 1/T12 solution and ICN 2 solution were fed into a static mixer at 238.4 grams/minute and 56.5 grams/minute respectively to provide an output rate of 294.9 grams/minute onto a borosilicate bead carrier 2 prepared as described above (Method for Making Bead Carrier) at a width of 44.5 centimeters (17.5 inches) using a knife coater. The coating was carried out at a speed of 9.14 meters/minute (30 feet/minute) then dried and cured in line in five ovens at 71° C., 93° C., 93° C., 93° C., 93° C., (160 F, 200° F., 200° F., 200° F., 200° F.) respectively. A dried coating weight of 40.4 grams/square meter (0.13 ounces/square foot) was thus provided. The approximate ratio of equivalents isocyanate to equivalents hydroxyl was 1.045:1.0. A borosilicate bead carrier 2 having a fluoro-urethane first layer thereon was thus obtained.

Part B: A 100% solids two part polyurethane was prepared by mixing vacuum degassed ICN 2 and POH 1 in a static mixer at 127.7 grams/minute and 106.0 grams/minute respectively to provide an output rate of 233.8 grams/minute onto the exposed surface of the first layer to obtain a dry areal weight of 118 grams/square meter (0.39 ounces/square foot). In addition, 549 ppm T12 (based on polyol) was included in the POH 1 feed. The coating was carried out at a speed of 4.57 meters/minute (15 feet/minute) then dried and cured in five ovens all set at 74° C. (165° F.). The approximate ratio of equivalents isocyanate to equivalents hydroxyl was 1.05:1.0. A transfer article having borosilicate beads which were partially embedded in polyethylene on one side and in the fluoro-urethane first layer on the other side, a coating of a polyurethane resin over the fluoro-urethane first layer, and PET 1 on the side of the polyurethane layer opposite that in contact with the first layer was obtained.

A 0.25 millimeters (0.010 inches) thick, bead film article having a fluoro-urethane first layer uniformly coated on one side with partially embedded borosilicate microsphere beads and on the other side with a layer of polyurethane resin, and PET 1 on the side of the polyurethane layer opposite that in contact with the first layer was obtained by removal of the transfer carrier.

### Example 1

Part A: An 18% solids (w/w) solution of FP1 in MIBK was applied onto a 35.6 centimeter (14 inches) wide soda lime silicate bead carrier, prepared as described above (Method for Making Bead Carrier), using a coating line with a 25.4 centimeter (10 inch) wide coating head and three drying ovens each set at 90° C., at a rate of 1.52 meters/minute (5 feet/minute). The total drying time was six minutes. The gap setting on the coating head was set to yield a dry areal weight of 18.95 grams of dry FP1/square meter (0.062 ounces of dry FP 1/square foot) of liner. After drying, samples of the fluoropolymer coated soda lime silicate bead carrier were plasma treated on their exposed fluoropolymer surface at 2000 Watts under 90 milliTorr, and a nitrogen flow rate of 1000 standard cubic centimeters/minute (sccm) at 3.0 meters/minute (10 feet/minute), using a homebuilt plasma treatment system described in detail in U.S. Pat. No. 5,888,594 (David et al.) with the following modifications: the width of the drum electrode was increased to 108 centimeters (42.5 inches) and the separation between the two compartments within the plasma system was removed so that all the pumping was carried out by means of the turbo-molecular pump. A soda lime silicate bead carrier having a plasma treated, fluoropolymer first layer thereon was thus obtained.

Next, a second coating was provided between the exposed, plasma treated fluoropolymer surface on the soda lime silicate bead carrier prepared as described above and a polyethylene-coated polyester liner. A mixture of 83.9 parts by weight of a vacuum degassed isocyanate blend containing ICN 1:ICN 2/79.7:4.2 (w/w) was combined with 100 parts by weight of a vacuum degassed polyol blend containing POH 2:POH 3/84:16 (w/w) and 900 ppm T12 (based on the combined weight of isocyanate and polyol components, and included in the polyol feed) using a static mixer to provide a 100% solids mixture having an approximate ratio of 1.025 equivalents isocyanate to 1.0 equivalents hydroxyl. The mixture was then coated between the exposed fluoropolymer surface of the soda lime silicate bead carrier having a plasma treated, fluoropolymer first layer thereon and a polyethylene-coated polyester release liner using a notch bar coater with a gap setting of approximately 0.076 millimeters (0.003 inches) greater than the combined thickness of the coated bead carrier and polyester film at a rate of approximately 1.5 meters/minute (5 feet/minute). The polyethylene surface of the polyester release liner was in contact with the polyurethane. After curing at 70° C. (158° F.) for five minutes a transfer article having soda lime silicate beads which were partially embedded in polyethylene on one side and in the fluoropolymer first layer on the other side, a coating of apolyurethane resin over the fluoropolymer first layer, and a polyethylene-coated polyester liner on the side of the polyurethane layer opposite that in contact with the first layer was obtained.

A bead film article having a fluoropolymer first layer uniformly coated on one side with partially embedded soda lime silicate microsphere beads and on the other side with a layer of polyurethane resin was obtained by removal of the transfer carrier and the polyethylene-coated polyester release liner.

Part B: A 100% solids two-part polyurethane foam was prepared by adding to a MAX 60 Long Speedmixer cup (FlackTek Inc, Landrum, S.C.) the following vacuum degassed materials: 25.35 grams POH 2, 0.09 grams POH 3, 122 microliters water, 127 microliters SI1, and 36 microliters T12. These were mixed at 3500 rpm for two minutes in a DAC 150.1 FVZ-K Speedmixer (FlackTek Inc, Landrum, S.C.). Next, 11.72 grams ICN 1 and 2.84 grams ICN 2 were then added to the cup and mixed for an additional 30 seconds at 2500 rpm. The resulting mixture coated between a silicone-coated polyester film release liner and a soda lime silicate bead carrier prepared as described above (Method for Making Bead Carrier) using a 30.5 centimeter (12 inch) wide notch bar coater having a gap setting of 0.33 millimeters (0.013 inches) greater than the combined thickness of the liners at a rate of about 3.0 meters/minute (10 feet/minute). This article was cured at room temperature for four minutes, followed by one hour in a forced air oven at 100° C. (212° F.). The silicone-coated polyester film release liner was removed and the article was returned to the forced air oven for an additional one hour. A transfer article having soda lime silicate beads which were partially embedded in polyethylene on one side and in the polyurethane foam layer on the other side was obtained.

Part C: The bead film article made in Part A was then laminated to the transfer article made in Part B using a 102 micrometer (0.004 inch) thick, extruded TPU. An air operated, automatic Digital Combo DC16AP 14×16 heat press (GeoKnight & Company Incorporated, Brockton, Mass.) having a 15.2 centimeter by 20.3 centimeter (6 inch by 8 inch) plate set up was used to bond the exposed surface of the TPU to the exposed surface of the polyurethane foam layer of Part B. The bottom plate temperature was set at 93° C. (200° F.) and top plate temperature was set at 121° C. (250° F.). The plates were brought together multiple times in different areas at a pressure of 41.4 Pascals (60 pounds/square inch) for 30 seconds to ensure good adhesion. After cooling, the release liner covering the exposed surface of the TPU was removed and the exposed TPU surface was joined to the exposed surface of the polyurethane layer of the bead film article prepared in Part A. This layup was heat bonded using multiple applications of pressure as described above.

A beaded foam laminate having, from top to bottom, a fluoropolymer first layer uniformly coated on its outer, exposed side with partially embedded soda lime silicate microsphere beads and on the other side with of polyurethane resin, TPU bonding layer, an polyurethane foam layer, and a soda lime silicate bead carrier with the beads partially embedded in the foam layer was obtained.

### Example 2

Example 1 was repeated with the following modifications. Part B was made using 244 microliters of water.

### Example 3

Example 1 was repeated with the following modifications. Part A was made at a coating weight of 25.2 grams of dry FP1/square meter (0.083 ounces of dry FP1/square foot) of liner; and Part B was made using 54 microliters of T12.

### Comparative Example 2

Comparative Example 1 was repeated with the following modifications. Part B was a 100% solids two-part polyurethane foam made by adding the following vacuum degassed materials to a MAX 40 Speedmixer cup (FlackTek Inc, Landrum, S.C.): 10.79 grams POH 1, 52 microliters water, 54 microliters SI1, and 18 microliters T12. These were mixed at 3500 rpm for one minute in a FlackTek Speedmixer. After mixing, 10.00 grams ICN 2 was then added to the cup and mixed for an additional minute at 3500 rpm. This mixture was then coated between a silicone-coated polyester film release liner and the exposed surface of the borosilicate bead carrier 2 having a fluoro-urethane first layer thereon using a notch bar coater with a gap setting of 0.076 millimeters (0.003 inches) greater than the combined thickness of the release liner and once coated bead carrier. The resulting twice coated, release liner covered, bead film was cured in a 80° C. (176° F.) forced air oven for one hour to provide a transfer article having borosilicate beads which were partially embedded in polyethylene on one side and in the fluoro-urethane first layer on the other, and a coating of polyurethane foam over the fluoro-urethane first layer, and a silicone-coated polyester film release liner on the side of the polyurethane layer opposite that in contact with the first layer was obtained.

A beaded foam article having a fluoro-urethane first layer uniformly coated on one side with partially embedded borosilicate beads and on the other side with a 100% solids-based, two part polyurethane foam was obtained by removal of both the transfer carrier and the silicone-coated polyester film release liner.

### Comparative Example 3

Comparative Example 2 was repeated with the following modification. Part B was made using 18 microliters of CAT 1 was used in place of T12.

### Comparative Example 4

Comparative Example 2 was repeated with the following modifications. Part B was made by adding the following vacuum degassed materials to a MAX 40 Speedmixer cup: 10.82 grams POH 1 and 260 microliters water, and mixing at 3500 rpm for one minute in a FlackTek Speedmixer; then 36 microliters of CAT 1 was added with mixing as before; then 52 microliters SI1 was added with mixing for two minutes. ICN 2, 10.05 grams, was then added to the cup and mixed for an additional minute at 3500 rpm. The resulting mixture was then coated between a silicone-coated polyester film release liner and the exposed surface of the borosilicate bead carrier 2 having a fluoro-urethane first layer thereon as described in Comparative Example 2.

### Comparative Example 5

Part A: A 60% solids solution in MEK of ICN 2 and a 60% solids solution in MEK of POH 1 containing 300 ppm T12 (based on the combined weight of isocyanate and polyol components) were combined using a static mixer in a weight ratio of 9 parts ICN 2 to 14.2 parts POH 1 to provide an approximate ratio of equivalents isocyanate to equivalents hydroxyl of 0.80:1.0. This mixture was coated onto a 30.5 centimeter (12 inch) wide borosilicate bead carrier 1 using a notch bar coater having a gap setting of approximately 0.10 millimeters (0.004 inches) at a pull through rate of approximately 3.0 to 3.7 meters/minute (10 to 12 feet/minute). This was then dried and cured in a forced air oven at 93° C. (200° F.) for five minutes. The resulting coated bead carrier 1 having a polyurethane first layer thereon was stored for two weeks.

Part B: A 100% solids, two-part polyurethane mixture was prepared by combining and mixing the following vacuum degassed materials in a cup using a centrifugal resin mixer at 3450 rpm for 30 seconds: 9.0 grams ICN 2, 14.2 grams POH 1, and seven microliters of T12. The approximate ratio of equivalents isocyanate to equivalents hydroxyl was 0.80:1.0. This was then coated between a silicone treated polyester film release liner and the exposed surface of borosilicate bead carrier 1 having a polyurethane first layer thereon using a notch bar coater with a gap setting of 0.051 millimeters (0.002 inches) greater than the combined thickness of the release liner and once coated bead carrier at approximately 3 meters/minute (10 feet/minute). The resulting twice coated, release liner covered, bead film was cured in a 70° C. (158° F.) forced air oven for one hour to provide a transfer article having borosilicate beads which were partially embedded in polyethylene on one side and in a two layered polyurethane resin on the other side, and a silicone-coated polyester film release liner on the side of the polyurethane layer furthest from the borosilicate beads. A 0.13 millimeters (0.005 inches) thick, bead film article having a two layered polyurethane uniformly coated on one side with partially embedded borosilicate beads was obtained by removal of both the transfer carrier and the silicone-coated polyester film release liner.

### Example 4

Example 1 was repeated with the following modifications. Part A included 0.75 wt % of Amine 1 (based on FP1); the third oven zone was set at 104° C. (219° F.); the coating gap was set at 0.18 millimeters (0.007 inches); and the second coating layer was omitted. Part B was prepared as follows. A 100% solids two-part, polyurethane foam was made by adding the following vacuum degassed materials to a MAX 60 Tall Speedmixer cup: 25.35 grams POH 2, 0.09 grams POH 3, 240 microliters water, 127 microliters SI1, and 36 microliters T12. These were mixed at 3500 rpm for one minute in a FlackTek Speedmixer. After mixing, 11.72 grams ICN 1, 2.84 grams ICN 2 were then added to the cup and mixed for an additional 30 seconds at 2500 rpm. The resulting mixture was applied to a 30.5 centimeter (12 inch) wide notch bar coater between a 0.18 millimeter (0.007 inch) thick PC/PBT film and resin coated borosilicate bead carrier 2 prepared as described above with a gap of 0.33 millimeters (0.013 inches) greater than the combined thickness of the liners at a rate of about 3.0 meters/minute (10 feet/minute). The film was cured at room temperature for four minutes, followed by one hour in a forced air oven at 80° C. (176° F.).

A transfer article having borosilicate beads which were partially embedded in polyethylene on one side and in the first layer on the other side, a coating of a polyurethane foam over the fluoropolymer first layer, and PC/PBT film on the side of the polyurethane foam layer opposite that in contact with the first layer was obtained.

A 0.25 millimeters (0.010 inches) thick, bead film article having a fluoropolymer first layer uniformly coated on one side with partially embedded borosilicate microsphere beads and on the other side with a layer of polyurethane foam, and PC/PBT film on the side of the polyurethane foam layer opposite that in contact with the first layer was obtained by removal of the transfer carrier.

### Example 5

A 100% solids two-part, polyurethane foam was prepared by adding the following vacuum degassed materials to a MAX 60 Tall Speedmixer cup: 17.10 grams POH 2; 4.28 grams POH 3; 164 microliters water; and 86 microliters SI1 and mixing at 3500 rpm for two minutes using a FlackTek Speedmixer. After mixing, 19.50 grams ICN 1 and 0.50 grams ICN 2 were then added to the cup and mixed for an additional 30 seconds at 2500 rpm. Finally, 36 microliters T12 was added and mixed for an additional 30 seconds at 2500 rpm. The resulting mixture was then coated as described in Example 4 using a soda lime silicate bead carrier.

A bead film article having a polyurethane foam layer uniformly coated on one side with partially embedded soda lime silicate microsphere beads and having on the other side PC/PBT film was obtained by removal of the transfer carrier.

### Example 6

Example 5 was repeated with the following modifications. The amounts used were 25.35 grams POH 2; 0.09 grams POH 3; 240 microliters water; and 127 microliters SI1; 11.72 grams ICN 1; 2.84 grams ICN 2; and 36 microliters T12.

A bead film article having a polyurethane foam layer uniformly coated on one side with partially embedded soda lime silicate microsphere beads and having on the other side PC/PBT film was obtained by removal of the transfer carrier.

### Example 7

Part A: A 20% solids (w/w) solution of FP1 in MIBK with 1.0% TALC (w/w based on FP1) was prepared by combining the materials in a sealed jar on a roller overnight at room temperature (ca. 23° C. (73° F.)). The resulting solution was applied onto a 35.6 centimeter (14 inch) wide soda lime silicate bead carrier, prepared as described above, using a notch bar coater and three drying ovens set at 90° C. (194° F.), 90° C. (194° F.), and 90° C. (194° F.) respectively at a rate of 1.52 meters/minute (5 feet/minute). The total drying time was six minutes. The gap on the coater was set to yield an areal weight of 23.1 grams of dry FP1/square meter (0.076 ounces/square foot) of liner. After drying the exposed fluoropolymer surface was plasma treated as described in Example 1.

Part B: Next, the exposed, treated fluoropolymer surface was coated with a 100% solids, two part, polyurethane resin by adding the following vacuum degassed materials to a MAX 40 Speedmixer cup: 12.33 grams ICN 1; 2.90 grams ICN 2; 23.80 grams POH 2; and 0.97 grams POH 3. Vacuum was applied directly to the cup for 15 seconds and followed by mixing at 2500 rpm for 30 seconds under full vacuum using a FlackTek Speedmixer. The sample was removed from the Speedmixer, 36 microliters T12 was added using a micropipette, the cup was again placed under vacuum for 15 seconds and mixed for an additional 30 seconds at 2500 rpm under full vacuum. The resulting mixture was applied between a silicone-coated polyester film release liner and a fluoropolymer first layer coated soda lime silicate bead carrier, prepared as described in Part A, at a rate of about 3.0 meters/minute (10 feet/minute) using a 30.5 centimeter (12 inch) wide notch bar coater having a gap setting of 0.33 millimeters (0.013 inches) greater than the combined thickness of the liners. The resulting twice coated, release liner covered, bead film was cured in five stages for 60 minutes each at the following temperatures: 40° C. (104° F.); 50° C. (122° F.); 60° C. (140° F.); 70° C. (158° F.); and finally at 80° C. (176° F.).

A transfer article having soda lime silicate beads which were partially embedded in polyethylene on one side and in the fluoropolymer first layer on the other side, and a coating of a polyurethane layer over the fluoropolymer first layer was obtained.

A 0.38 millimeters (0.015 inches) thick, bead film article having a fluoropolymer first layer uniformly coated on one side with partially embedded soda lime silicate microsphere beads and having on the other side a layer of polyurethane was obtained by removal of the transfer carrier and the silicone-coated polyester film release liner.

TABLE 1

| | Gloss Change | Compression | Retroreflectivity (Rₐ) |
|---|---|---|---|
| Example | at 85° Angle | Modulus (MPa) | (Candelas/square meter/lux) |
| CE 1 | 1.15 | NT* | 0.0 |
| 1 | 0.15 | 0.09 | 0.0 |
| 2 | 0.10 | 0.09 | 0.0 |
| 3 | 0.15 | 0.10 | 0.0 |
| CE 2 | 1.10 | 0.18 | 0.0 |
| CE 3 | 1.20 | 0.47 | 0.0 |
| CE 4 | 2.95 | 0.52 | 0.0 |
| CE 5 | 1.50 | NT* | 0.0 |
| 4 | 0.00 | 0.04 | 0.0 |
| 5 | −0.10 | 0.17 | 0.0 |
| 6 | −0.05 | 0.05 | 0.0 |
| 7 | 0.10 | 0.22 | 0.0 |

*unable to test using compression modulus test due to high stiffness of construction

TABLE 2

| Example | Stain Resistance (delta b*) |
|---|---|
| 4 | 13.62 |
| 7 | 5.32 |

TABLE 3

| Example | Solvent Resistance |
|---|---|
| CE 1 | Pass |
| CE 2 | Pass |
| CE 3 | Pass |
| CE 4 | Pass |
| CE 5 | Pass |
| 4 | Pass |
| 5 | Pass |
| 6 | Pass |
| 7 | Pass |

TABLE 4

| Example | Film Thickness (mm) | Elongation at Failure (%) |
|---|---|---|
| 7 | 0.104 | >300 |

### Blending of POH 5 and POH 4

A clear mixture of 95 grams of POH 5 and 5 grams of POH 4 was prepared as follows. The POH 5 and POH 4 were added to a 250 milliliter jar which was then sealed and heated at 70° C. (158° F.) for twelve hours, then placed on a mechanical roller at room temperature for six hours. This heating and rolling process was repeated as follows to give a clear, homogenous mixture: 1 hour at 70° C., 1 hour on roller, 1 hour at 70° C., allowed to cool on a benchtop.

### Example 8

A 100% solids two-part polyurethane was prepared by adding the following vacuum degassed materials to a MAX 60 Speedmixer cup: 12.08 grams of a blend of ICN 1:ICN 2 (85:15/w:w), and 46.15 grams of the POH 5/POH4 blend described above. After applying vacuum for 15 seconds the components were mixed under vacuum at 2600 rpm for 45 seconds using a FlackTek Speedmixer. Next, the cup was removed from the mixer, 52 microliters T12 was added, and the components were degassed and mixed as before.

The resulting mixture was applied between a polyethylene-coated polyester film release liner and a borosilicate bead carrier 2 using a notchbar coater as described in Example 7 with the following modification. The gap setting employed was 0.30 millimeters (0.012 inches).

The resulting once coated, release liner covered, bead film was cured first at room temperature for two hours then heated in five stages for 60 minutes each as follows: 40° C. (104° F.); 50° C. (122° F.); 60° C. (140° F.); 70° C. (158° F.); and finally at 80° C. (176° F.).

A transfer article having borosilicate beads which were partially embedded in polyethylene on one side and in the polycarbonate-based polyurethane resin on the other side, and a polyethylene-coated polyester film release liner on the opposite side of the polyurethane layer from that containing the beads was obtained.

A 0.46 millimeters (0.018 inches) thick, bead film article uniformly coated on one side with partially embedded borosilicate microsphere beads and having on the other a layer of polycarbonate-based polyurethane was obtained after removal of the transfer carrier and the polyethylene-coated polyester film release liner.

### Example 9

A 100% solids two-part, polyurethane foam was prepared by adding the following materials to a MAX 60 Speedmixer cup: 26.89 grams POH 5, 1.52 grams POH 4, and 0.15 grams water. These were mixed at 2700 rpm for one minute using a FlackTek Speedmixer after which 150 microliters SI2 and 36 microliters T12 were added followed by mixing as before. Next, 8.50 grams ICN 1 and 1.50 grams ICN 2 were added to the cup and mixed for an additional minute as before.

The resulting mixture was applied between a borosilicate bead carrier 2 and plasma treated PC/PBT film with a gap of 0.33 millimeters (0.013 inches) greater than the combined thickness of the liner and the PC/PBT film at a rate of about 3.0 meters/minute (10 feet/minute) using a 30.5 centimeter (12 inch) wide notch bar coater. The mixture was in contact with the plasma treated surface of the PC/PBT film. The plasma treatment was carried out generally as described in U.S. Pat. No. 8,634,146 (David et al.) at column 13, line 65 to column 14, line 30, with the following modifications. The width of the drum electrode was 108 centimeters (42.5 inches); the tetramethyl silane deposition step was not employed; during the treatment step 1000 standard cubic centimeters/minute (sccm) of nitrogen was used in place of oxygen; the operating pressure was 90 milliTorr; and the plasma treatment time was 30 seconds. The resulting once coated, plasma treated PC/PBT covered bead film was cured first at room temperature for 30 minutes then heated at 80° C. for one hour.

A transfer article having borosilicate beads which were partially embedded in polyethylene on one side and in a polycarbonate-based polyurethane foam on the other side, and having plasma treated PC/PBT film on the side of the polyurethane foam layer opposite that in contact with bead carrier 2 was obtained.

A 1.68 millimeters (0.066 inches) thick, bead film article having partially embedded borosilicate microsphere beads on one side of a polycarbonate-based polyurethane foam, and having plasma treated PC/PBT film on the opposite side of the polyurethane foam was obtained by removal of the transfer carrier.

### Example 10

Part A: A 15% solids (w/w) solution of FP2 in MIBK with 1% TALC (w/w based on FP2) was prepared by combining the materials in a sealed jar on a roller overnight at room temperature. The resulting solution was applied onto a 35.6 centimeter (14 inch) wide borosilicate bead carrier 2, prepared as described above, using a coating line having a 25.4 centimeter (10 inch wide coating head, three drying ovens each set at 90° C. (194° F.), at a rate of 1.52 meters/minute (5 feet/minute). The total drying time was six minutes. The feed rate was set to yield an areal weight of 18.95 grams dry FP2/square meter (0.062 ounces dry FP2/square foot) of liner. After drying, samples of the fluoropolymer coated borosilicate bead carrier 2 were plasma treated as described in Example 1. A borosilicate bead carrier 2 having a plasma treated, fluoropolymer first layer thereon was thus obtained.

Part B: A 100% solids two-part, polyurethane foam was prepared as follows. The following materials were added to a MAX 60 Speedmixer cup: 26.93 grams POH 5, 1.52 grams POH 4, and 0.15 grams water. These were mixed at 2700 rpm for one minute using a FlackTek Speedmixer after which 150 microliters SI2 and 36 microliters T12 were added followed by mixing as before. Next, 8.50 grams ICN 1 and 1.50 grams ICN 2 were added to the cup and mixed for an additional minute as before. The resulting mixture was applied between a borosilicate bead carrier 2 and the plasma treated PC/PBT film with a gap of 0.33 millimeters (0.013 inches) greater than the combined thickness of the liner and the PC/PBT film at a rate of about 3.0 meters/minute (10 feet/minute) using a 30.5 centimeter (12 inch) wide notch bar coater. The mixture was in contact with the plasma treated surface of the PC/PBT film. The resulting once coated, plasma treated PC/PBT covered bead film was cured first at room temperature for 30 minutes then heated at 80° C. (176° F.) for 50 minutes.

A transfer article having borosilicate beads which were partially embedded in polyethylene on one side and in the fluoropolymer first layer on the other side, a coating of a polycarbonate-based polyurethane foam layer over the fluoropolymer first layer on the other side, and having plasma treated PC/PBT film on the side of the polycarbonate-based polyurethane foam layer opposite that in contact with fluoropolymer first layer was obtained.

A 1.47 millimeters (0.058 inches) thick, bead film article having a fluoropolymer first layer uniformly coated on one side with partially embedded borosilicate microsphere beads and on the other side with a layer of polycarbonate-based polyurethane foam, and having plasma treated PC/PBT film on the opposite side of the polycarbonate-based polyurethane foam was obtained by removal of the transfer carrier.

### Example 11

Example 9 was repeated but with the following modifications: 27.81 grams POH 5; 1.49 grams POH 4; 0.165 grams water; 35 microliters T12; 150 microliters SI1; and 10.07 grams of a mixture of ICN 1:ICN 2 (85:15/w:w) were employed. The resulting once coated, plasma treated PC/PBT covered bead film was cured first at room temperature for 30 minutes then heated at 93° C. (199° F.) for one hour.

A 2.86 millimeters (0.113 inches) thick, bead film article having partially embedded borosilicate microsphere beads on one side of a polycarbonate-based polyurethane foam, and having plasma treated PC/PBT film on the opposite side of the polyurethane foam was obtained by removal of the transfer carrier.

### Example 12

Example 9 was repeated but with the following modifications: 27.53 grams of a blend of POH 5:POH 4 (95:5/w:w); 0.130 grams water; 35 microliters T12; 150 microliters SI1; and 10.05 grams of a mixture of ICN 1:ICN 2 (85:15/w:w) were employed. The resulting once coated, plasma treated PC/PBT covered bead film was cured first at room temperature for 5 minutes then heated at 93° C. (199° F.) for one hour.

A 1.89 millimeters (0.074 inches) thick, bead film article having partially embedded borosilicate microsphere beads on one side of a polycarbonate-based polyurethane foam, and having plasma treated PC/PBT film on the opposite side of the polyurethane foam was obtained by removal of the transfer carrier.

TABLE 5

| | Compression | | Reflectivity (Ra) | | Stain | |
|---|---|---|---|---|---|---|
| | Modulus | Gloss Change | (Candelas/square | | Resistance | Elongation at |
| Example | (MPa) | at 85° Angle | meter/lux) | COF | (delta b*) | Failure (%) |
| 8 | 0.384 | 0.0 | 0.07 | 0.294 | NT | 756 |
| 9 | 0.117 | 0.1 | 0.22 | 0.264 | 90.50 | NT |
| 10 | 0.106 | 0.0 | 0.19 | 0.240 | 11.63 | NT |
| 11 | 0.109 | 0.0 | 0.23 | 0.293 | NT | NT |
| 12 | 0.306 | 0.1 | 0.14 | 0.233 | NT | NT |

NT: Not Tested

1. An article comprising:
(a) a compliant article wherein the compliant article comprises an polymer layer and a first layer disposed along a first major surface of the polymer layer; and
(b) a plurality of microspheres partially embedded and adhered to a major surface of the first layer opposite the surface that is disposed along the first major surface of the polymer layer,
wherein the article has a compression modulus of less than or equal to 0.5 MPa.

2. The article of claim 1 wherein the first layer is selected such that the article exhibits a stain resistance to yellow mustard at elevated temperature and humidity as measured by the change in b* of less than 70.

3. The article of claim 1, wherein the thickness of the compliant article is greater than 50 microns.

4. The article of claim 1, wherein the first layer is selected from at least one of linear resins and resins having low cross link densities.

5. The article of claim 4, wherein the linear resins are selected from at least one of the following linear materials: polyurethanes, polyureas, polyurethane ureas, polypolyesters, polycarbonate, ABS, polyolefins, acrylic and methacrylic acid ester polymers and copolymers, polyvinyl chloride polymers and copolymers, polyvinyl acetate polymers and copolymers, polyamide polymers and copolymers, fluorine containing polymers and copolymers, silicones, silicone containing copolymers, thermoplastic elastomers, such as neoprene, acrylonitrile butadiene copolymers, and combinations thereof.

6. The article of claim 4 wherein the article has an elongation percent at failure of greater than 26%.

7. The article of claim 1 wherein the plurality of microspheres are selected from at least one of glass, polymers, glass ceramics, ceramics, metals and combinations thereof.

8. The article of claim 1 further comprising a second layer disposed along the second major surface of the compliant article.

9. The article of claim 8 wherein the second layer comprises a flexible material.

10. The article of claim 1 wherein the article is resistant to organic solvents.

11. The article of claim 1 wherein the article exhibits a coefficient of friction of less than or equal to 0.3.

12. The article of claim 1 wherein the article is heat bonded at elevated temperatures to a substrate.

13. The article of claim 1 wherein the polymer layer comprises an aliphatic polyurethane polymer comprising a plurality of soft segments, and a plurality of hard segments, wherein the soft segments comprise poly(alkoxy) polyol, polycarbonate polyol or combinations thereof, and wherein the soft segment is essentially free of crosslinker.

14. The article of claim 13 wherein the soft segments have a number average molecular weight of less than 10,000 g/mol, and wherein the hard segments are derived from diols having molecular weights of less than 600 g/mol.

15. The article of claim 13 wherein the soft segments have a number average molecular weight of at least 500 g/mol.

16. The article of claim 13 wherein the soft segments have a number average molecular weight of 500 g/mol to 6,000 g/mol.

17. The article of claim 13 wherein the soft segments have a number average molecular weight of 500 g/mol to 3,000 g/mol.

18. The article of claim 13 wherein the compliant article has a thickness of 50 to 600 microns, and includes microspheres having an average diameter of about 30 to 200 microns.

19. The article of claim 13 wherein the aliphatic polyurethane polymer contains less than 50 percent by weight hard segments and 15 to 90 percent by weight soft segments.

20. The article of claim 13 wherein the total amount of hard and soft segments in the aliphatic polyurethane polymer is at least 90 percent by weight of the polymer.

21. The article of claim 1 further comprising at least one additional layer disposed between the first layer and the polymer layer.

22. The article of claim 21 further comprising a second additional layer disposed between the polyurethane layer and the polymer layer.

23. An article comprising:
(a) a compliant article wherein the compliant article comprises a polymer layer; and
(b) a plurality of microspheres partially embedded and adhered to a major surface of the compliant article,
wherein the article has a compression modulus of less than or equal to 0.5 MPa, and further wherein the article is a decorative article.

24. The article of claim 23 wherein the compliant article further comprises a first layer disposed between the polymer layer and the plurality of microspheres.

25. The article of claim 24 wherein the first layer is selected such that the article exhibits a stain resistance to yellow mustard at elevated temperature and humidity as measured by the change in b* of less than 70.

26. The article of claim 23, wherein the thickness of the compliant article is greater than 50 microns.

27. The article of claim 24 wherein the first layer is selected from at least one of linear resins and resins having low cross link densities.

28. The article of claim 27, wherein the linear resins are selected from at least one of the following linear materials: polyurethanes, polyureas, polyurethane ureas, polypolyesters, polycarbonate, ABS, polyolefins, acrylic and methacrylic acid ester polymers and copolymers, polyvinyl chloride polymers and copolymers, polyvinyl acetate polymers and copolymers, polyamide polymers and copolymers, fluorine containing polymers and copolymers, silicones, silicone containing copolymers, thermoplastic elastomers, such as neoprene, acrylonitrile butadiene copolymers, and combinations thereof.

29. The article of claim 27 wherein the article has an elongation percent at failure of greater than 26%.

30. The article of claim 23 wherein the plurality of microspheres are selected from at least one of glass, polymers, glass ceramics, ceramics, metals and combinations thereof.

31. The article of claim 23 further comprising a second layer disposed along the second major surface of the compliant article.

32. The article of claim 23 wherein the second layer comprises a flexible material.

33. The article of claim 23 wherein the article is resistant to organic solvents.

34. The article of claim 23 wherein the article exhibits a coefficient of friction of less than or equal to 0.3.

35. The article of claim 23 wherein the article is heat bonded at elevated temperatures to a substrate.

36. The article of claim 23 wherein the polymer layer comprises an aliphatic polyurethane polymer comprising a plurality of soft segments, and a plurality of hard segments, wherein the soft segments comprise poly(alkoxy) polyol, polycarbonate polyols, or combinations thereof, and wherein the soft segment is essentially free of crosslinker.

37. The article of claim 36 wherein the soft segments have a number average molecular weight of less than 10,000 g/mol, and wherein the hard segments are derived from diols having molecular weights of less than 600 g/mol.

38. The article of claim 36 wherein the soft segments have a number average molecular weight of at least 500 g/mol.

39. The article of claim 36 wherein the soft segments have a number average molecular weight of 500 g/mol to 6,000 g/mol.

40. The article of claim 36 wherein the soft segments have a number average molecular weight of 500 g/mol to 3,000 g/mol.

41. The article of claim 36 wherein the polymer layer has a thickness of 50 to 600 microns, and includes microspheres having an average diameter of about 30 to 200 microns.

42. The article of claim 36 wherein the polyurethane polymer contains less than 50 percent by weight hard segments and 15 to 90 percent by weight soft segments.

43. The article of claim 36 wherein the total amount of hard and soft segments in the polyurethane polymer is at least 90 percent by weight of the polymer.

44. The article of claim 1 wherein the article has a gloss change at 85° Angle of less than or equal to 1.00 according the Abrasion Resistance Test.

45. The article of claim 23 wherein the article has a gloss change at 85° Angle of less than or equal to 1.00 according the Abrasion Resistance Test.
